(19) United States
(12) Patent Application Publication
(10) Pub. No.: US 2013/0275116 A1
(43) Pub. Date: Oct. 17, 2013

(54) Interactive, live-connection, specifically targetable, database-supported, dynamic dialogue management engine

(71) Applicant: Electionear, Inc., (US)

(72) Inventors: Ralph Garvin, JR., San Francisco, CA (US); Anthony Gooran, San Francisco, CA (US)

(73) Assignee: Electionear, Inc., San Francisco, CA (US)

(21) Appl. No.: 13/694,756

(22) Filed: Dec. 30, 2012

Related U.S. Application Data
(60) Provisional application No. 61/582,325, filed on Dec. 31, 2011.

(51) Int. Cl. G06F 17/20

(52) U.S. Cl. CPC G06F 17/20
USPC 704/2; 704/9

(57) ABSTRACT

This invention is a Dynamic Dialogue Management Engine that enables a single person to create, monitor, manage, and adapt a dialogue between one source and a plurality of specifically identified, validated, and contacted individuals. A Field Operator engages each such ‘targeted’ individual in a real-time communication using face-to-face geospatially-shared contact or telephony once that specific communications link has been made. This tuple's dialogue is a two-way exchange with the Field Operator taking and reporting data from, and about, the Targeted Individual as well as communicating the information (or asking the specific questions) set by the Communications Manager to the Targeted Individual. All instantiations of the dialogue are aggregated and analyzed using the data gathered through the real world experiences of the Field Operatives with the Targeted Individuals and the dialogue is responsively and dynamically adapted to meet the central purpose thereof by the Communications Manager.

### CROSS-REFERENCE TO RELATED PROVISIONAL PATENT APPLICATION

This application is a continuation of the provisional patent application 61/582,325 titled “Systems and Methods for Organizing, Running, Tracking, Analyzing, Communicating, and Managing Field Operations in Real Time Using Networked Mobile Devices”, filed on Dec. 31, 2011 and includes at least one common inventor between this application and said provisional application, which it hereby incorporates entirely, specification and drawings, by express reference.

### FIELD OF THE INVENTION

This invention relates to the general field of dialogue management, that is, communications from one governing source both to and with a number, presumably a great number, of distinct and individual adult human beings, concerning a topic or question of interest. The invention requires computer processing, telephony and data communications devices, and database storage, retrieval, analysis, and modification efforts, to support this process, particularly as the scope and extent of specifics of both the communications and the dialogue states and logic exceed the limits of any human. While the telephony and data communications devices in the preferred embodiment include mobile devices (handsets, smartphones, tablets, notepads, notebooks), and the data storage, retrieval, analysis, modification—including deletion, alteration, addition to the database either as a whole (categorical modification) or in particulars (data records updating)—require computer processor use, active and long-term storage memories, databus transmissions, and (for each element which a human user interacts with) a user-accessed input/output display and control, the invention is not of a specific mobile device, computer processor, database, or database management tool.

### BACKGROUND OF THE INVENTION

Dialogue is defined as ‘a conversation between two or more people’, or more precisely, ‘an exchange of ideas and opinions’. (American Heritage Dictionary of the English Language, (c) 1969, Wm. Morris, Ed.; Houghton-Mifflin Company, p. 364) Most people are familiar with both a dialogue between individuals and a dialogue between an organization (constituting one set of individuals) and a group (constituting another, possibly overlapping, set of individuals). A dialogue consists of more than a single exchange and response (or question and answer); and, in addition to a central concern, topic, message, or purpose, it consists of a series of sub-states which are serially shared between any pairing of two individuals currently interacting. For one-to-many, and many-to-many interactions, a set of sub-states, though depending upon the particular choices made by the pair communicating, (and not necessarily each single sub-state) are generally shared amongst all those participating.

Dialogue management is the task of initiating, monitoring, and responding to the experienced subordinate sub-state interchanges in such fashion as to keep the process and dialogue moving within the acceptable bounds—or arrange for its termination when the participants move beyond the context and limits of the dialogue. Dialogue management includes monitoring, guiding, and as necessary inhibiting expressions issued by individuals on behalf of the dialogue source (e.g. preventing assertions which are not authorized by the dialogue source, or which are not relevant to contradict the dialogue source's base assumptions and reasoning), and monitoring, recording, and analyzing the other person's (and persons') responses, including further inquiries, need for addition informational detail, or expressed desire for further interaction.

A political campaign is a dialogue, between the proponent (or candidate) seeking electoral support for his position, and the target voters. Campaigns often use volunteers and/or paid canvassers to engage in dialogues with the voters. The campaign may start with, or build, a database of possible voters, which it then uses to qualify potential contacts, make specific contacts, and record the interaction results from such contacts. Campaigns seek to manage the dialogue (particularly, to ‘stay on message’) for the campaign as a whole, which in turns means monitoring, and as necessary constraining or less-preferentially correcting, mistaken sub-dialogues between individual volunteers/canvassers and voters.

The general model for dialogue management for a campaign is a one-to-many and one-from-many interaction, moderated through a series of one-with-one communications between individual volunteers and potential voters. A script of questions and potential sets of answers will be given to each campaign communicator, to be used in each individual communication. The set of campaign communicators will return to the central operating group with the results from the day's activity. These results are then used to build and/or modify a central database for the campaign, indicating what the voters are actually, as opposed to predictively, concerned with and stating about the campaign's topic of interest.

The prior art of dialogue management separated the collection and validation of the data identifying potential targets for communication, the transmission and reception of data relevant to the topic of the communication, and the effort of dialogue management. The prior art generally required manual entry to be repeated (each repeat introducing a chance for error), was only aggregated in discontinuous batches (often overnight), and did not allow dynamic modification of the process of the dialog in response to the experienced specific interactions from the voters with the volunteers/canvassers. Overall it was error-prone, difficult and frustrating to implement, costly, non-transparent, static or changeable only with discontinuous jerks, and above all, inflexible and non-adaptive to immediacy of field experiences.

At present the industry-leading tool which can be applied to dialogue management is NGP VAN's “SmartVAN”. They describe it thusly:
“VAN's Create-A-List is the industry-leading list segmentation tool, delivering a balance of powerful options, intuitive interface and speed, allowing precision targeting. Sophisticated features enable door-to door canvassing, including turf cutting, and our free MiniVAN app allows you to use an iPhone, iPad or iPod Touch to collect information at the door, eliminating the soggy clipboard.” (See: http://www.ngpvan.com/smartvan.) SmartVAN has its origins as an older application developed for the Palm Pilot, and it compares to the present invention much as the Apple Newton compares to the iPhone: something with a very limited functionality which addressed different questions with a different solution. SmartVan is a list-processing system which lacks integrated analytics to be used with the data in the list to generate new conclusions (as opposed to different lists). It also does not allow the list to be updated to reality, or to be cross-referenced with other data, nor does it present relevant and validated data from the list specifically through other means (graphical or map-based visualizations, as opposed to text lists). Furthermore, SmartVAN lacks third-party data integration means, geopositioning commonality, and cannot be extended to non-proprietary and inexpensive new devices, being limited to the Apple i-Line. A free, lesser version is called MiniVAN, which they describe as a:
“mobile canvassing application that allows users to export canvassing lists from the VAN onto a mobile device (including iPhone, iPod Touch, iPad, and Android phones and tablets).” (http://www.ngpvan.com/voter-contact)

But the largest single lack in SmartVAN is its inability to dynamically alter the data within the list based on the exchanges in the real world when the latter establish that the ‘data map’ is not an accurate representation of reality; SmartVAN lacks dynamic fidelity. (It is possible to effect the changes but only through a delayed ‘batch processing’ effort; which slows the adaptation of the field personnel and dialogue manager, both.) Furthermore, while these applications allow data transfer, they do not simultaneously provide telephone communication.

A second tool which again can be applied to dialogue management is Moonshadow Mobile. (See: http://www.moonshadowmobile.com/data-visualization/ground-game/.) A principle weakness of this tool as it is, is its dependence upon its proprietary lists; it does not manage its own data or allow user-specific development, correction, storage, updating, and use of data generated by using of Moonshadow Mobile. As with the previous tool, Moonshadow Mobile also lacks the ability to dynamically alter the data within the list based on the exchanges in the real world when the latter establish that the ‘data map’ is not an accurate representation of reality; Moonshadow Mobile also lacks dynamic fidelity.

A third tool which also can be applied to dialogue management is “Walking Edge”, a tool developed by Edge Targeting, LLC. Missing from this product is the ability to provide analytical or real-time field operations management capability, so it cannot provide planning, monitoring, and analysis of the field operation in real time (or otherwise without moving into third-party, separate, tools). Furthermore, Walking Edge is designed to be a ‘web-only’ operating tool, which means that it will not work in areas without an accessible link signal—which includes many prime areas for dialogue, namely, apartments, city neighborhoods, and rural households. It also is unable to coordinate with the specific person's information which is communal but not demographically descriptive, such as identifying for an individual where her, or his, polling location will be or is.

Another limited-overlap effort is offered by Grassroots Unwired (see: http://www.grassrootsunwired.com/). This is another list-processing based technology which does obtain data and feed it back to a source, but does so to predetermined reports, tables, graphs, or other lists—using the pre-fixed attribute set, rather than attribute-interactive, analytical mechanisms. (See: http://www.grassrootsunwired.com/solutions/.) It lacks any interactivity or dynamic capability as the data which is captured does not connect with, but is only conveyed through the limited script presented by this tool. Furthermore, it lacks capacity to build a datarecord (not even a ‘new list’) or datasource and makes no use of integrated voice and data telephony.

Yet another limited-overlap effort is offered by the ES400 Smartphone. A particular phone that runs only on a particular network, it fails to offer integrated telephony (despite its hardware platform), does not integrate with any data-management (backend) processing system, completely lacks the dynamic integration of data-fidelity and dialogue management capabilities, and considers all information flow other than contact establishment to be ‘source-directed’ rather than a fully interactive exchange. See: http://www.motorola.com/Business/US-EN/Business+Product+and+Services/165 Mobile+Computers/Handheld+Computers/ES400_US-EN.

Three other minor tools which are not in the field are the Organizer Toolbox (created collaboratively by the U. of Washington and Google), the Open Data Toolkit, and ClickSoftware's ClickMobile Apps. The first is primarily an online, application-enabling, report creation tool which uses field-gathered data to produce a single centralized summation (but not to feed the same dynamically back to the field operatives gathering the data). The second is a programming tool that supports the development of native Android-based applications to collect data. The third is a set of ‘apps’ for mobile phones which are programmable, rather than representing an existing solution. None of these standing alone cannot provide the functionality of dialogue management; they are not sufficiently specialized to be efficiently used in field operations where a realtime dialogue between many sets of individuals is being managed by a central intelligence. Essentially these are various toolkits and some of the building materials . . . but none are a finished, working Engine.

None of the above take into account the ‘Heisenberg effect’, i.e. the effect that the field operative's presence, capacities, and background, will have or might have on the contacted individual's capability to hear (as opposed to merely listen to) the dialogue's message.

Dialogue management requires communications management which includes live integration —so that what happens in the field at one specific interchange can immediately be used to affect other ongoing, and future, interchanges; which includes live phonebank and live field efforts, where the communications manager can find out who is actually home and direct the best available field operative to make a in-person connection; which allows dynamic queries within the overall dialogue, such that interim answers determine the choice points, and subsequent specific interchanges, that a live pair of individuals share which are specifically focused on the interests and dependent upon the responses of the targeted individual who has been contacted, without moving beyond the overall scope of the dialogue or authorization (or knowledge) of the field operative; which allow integration of multiple forms of data representation (textual, graphical, map-display) as best communicates at each stage of the overall dialogue; and which effectively ‘decompose’ the overall script to the path-set appropriate to that particular target while simultaneously displaying the operative best selection to the field operative, with the analysis of all current field interchanges driving the real-time analytical assessment of what is, for that specific individual pair, best able to communicate.

### SUMMARY OF THE INVENTION

The present invention is a dynamic dialogue management engine (‘DDME’) whereby a dialogue from a single source to a plurality of specific individuals, which takes place through communications within and between a set of tuples of Field Operatives and Targeted Individuals, is initiated, monitored, analyzed, supported, recorded, and managed; with each specific communication being both live (between human beings) and conducted in real-time (instead of asynchronously) between Field Operative and Targeted Individual in each specific tuple, even as the entire set of communications comprising the dialogue are being dynamically analyzed and adapted by a central Communications Manager for the entire set of tuples (past and present) responding to the interactive, particular experience of any or each particular tuple (or subset of all tuples) of Field Operative and Targeted Individual.

The structure of the dialogue can be altered for each particular tuple according to the interactions actually experienced not just by that tuple, but for any in the set. This dynamic interaction can modify, enhance, or eliminate particular sub-portions of the dialogue which are found to be irrelevant or ineffective communications (for that tuple or for the entire group). The process through the dialogue can also be altered according to the nature of the Field Operative in the context of the specific Targeted individual, within the limits established and managed by the Communications Manager (by providing, for example, a pairing of language cues specific to the particular pair of languages preferred by a Field Operative and the specific Targeted Individual with whom he is presently interacting). Also, the process can be altered according to the choices made by the Targeted Individual in his answers or volunteered information.

Just as importantly, however, the Communications Manager can use the DDME, combining the strengths of telephonic switching and datasource management, to allocate his Field Operatives into one-on-one direct communications with a quantitatively equal set of live, contacted Targeted Individuals, with each Field Operative knowing both which precise Targeted Individual is in contact and whatever source information the DDME contains in the datasources identifying that Targeted Individual, successively through a plurality of Targeted Individuals larger than the set of Field Operatives. This allows the Field Operatives to validate the fidelity of each specific data record, while the Communications Manager uses additional bandwidth of telephonic switching to attempt to initiate contacts as individual Field Operatives complete their respective interactions to avoid ‘dead time’. Field Operatives or canvassers are spared from the effort of making the non-completed calls and the scarce human interactivity is kept for, and dynamically allocated to, completed communication linkage with live human beings at both ends.

In a distinct use the Communications Manager can use the DDME to direct the set of Field Operatives to effect follow-up efforts, either communicative or supportive towards the purpose of the dialogue, which will engage the Targeted Individual in that fashion both agreeable and agreed to by the Targeted Individual, thereby furthering the purpose of the dialogue. For example a Communications Manager could initiate, for a set of previously-qualified likely voters, a communications link effort combining live connections between as many actually-connected voters as there are Field Operatives, with each Field Operative interacting with a specific, Targeted Individual for a ‘reminder call’; or (for the same set and number of Field Operatives) a physical ‘get out the vote’ effort to provide transport for as many Targeted Individuals as there are Field Operatives (defining the latter as those both capable of transporting a voter to his or her voting place). Provided to each Field Operative would be information as to the location and operating state of that Targeted Individual's voting place, or the request for a reminder (and encouragement) to vote entered earlier by that Targeted Individual. As soon as any Field Operative completes an interaction with one Targeted Individual the automated telephony linker would establish a subsequent communications link with another, previously-validated, Targeted Individual, while the Datastore would indicate to the Field Operative the nature of the past interaction and the requested or desired support previously given by that specific Targeted Individual. The communicative or supportive efforts could also be for any of a wide set of efforts including commercial exchange, informational, emergency notification, emergency assistance, health or environmental notification or assistance, or community action(s).

In a separate distinct use the Communications Manager can use the DDME to supervise and direct a canvassing operation, using the set of Field Operatives and handsets and datasources, through any combination of live telephony and live on-the-ground direct face-to-face contacts.

In a separate distinct use the Communications Manager can use the DDME to supervise and manage the interaction between a tuple of a set of Field Operatives and a second set of Targeted Individuals, wherein the interaction occurs through a social media or social networking application. The constraints and limits of the dialogue can be effected through provision of a specific ‘app’ generated through the DDME, which app contains the approved structure, sub-elements, and approved process effectors of the dialogue as a whole to the Field Operative, who uses that app to effect the interaction between himself and the Targeted Individual, and by such use interactively updates the DDME and datasources as to the fidelity of a datarecord (or in the case of a discovered discrepancy, a corrective update).

### BRIEF DESCRIPTION OF THE SEVERAL VIEWS OF THE DRAWINGS

FIG. 1 shows the hardware elements and their connections (voice telephony by dashed lines, data telephony by solid lines) which comprise the architecture for the DDME.

FIG. 2 shows the display and controls of a hardware element of the DDME.

FIG. 3 shows the display and controls of the same hardware element of the DDME reflecting progress made by the Field Operative using it.

FIG. 4 shows the display and controls of the same hardware element offering the Field Operative a particular starting script.

FIG. 5 shows the display of the same hardware element during the progress of communication at a specific state of the script with a decision point.

FIG. 6 shows the display of the same hardware element upon the entry of the Target's response with that being visibly differentiated from the non-selected response(s).

FIG. 7 shows the display of the same hardware element upon the entry by the Field Operative of a Target's non-member response that is being or will be communicated to the Communication Manager's hardware element (not shown).

FIG. 8 shows the display of the Communication Manager's hardware element aggregating from the set of Field Operative hardware elements responses from the set of Target Individuals.

FIG. 9 shows the display of each Field Operative's particular hardware element updated by the Communications Manager to incorporate a modified set of exceptions.

FIG. 10 shows the information-related interconnectivity of the system. As in FIG. 1, voice telephony is indicated by dashed lines, and data telephony by solid lines.

FIG. 11 shows an exemplar of the interactive dialog control used by the Communications Manager to supervise and as desired dynamically adjust the process of communication for either a specific Field Operative or, through modification of the DataStore (not shown) the set of Field Operatives, depending upon the response at a specific decision point.

FIG. 12 shows an exemplar of the communications dialog oversight and state operations used by the Communications Manager to supervise and as desired dynamically adjust the process of communication for either a specific Field Operative or, by modifying the state logic of the dialog, the set of Field Operatives.

FIG. 13 shows the display and controls on a Field Operative's hardware element when a live communications link has been established with a current Targeted Individual, with a supportive set of possible responses in the paralleled language.

FIG. 14 is a simplified example of a dialogue.

FIG. 15 is a simplified example of a financial exchange sub-state.

FIG. 16 is a simplified example of the financial exchange sub-state shown in FIG. 15 after it has been dynamically modified by the Communications Manager.

FIG. 17 is a simplified example of the Communications Manager using the DDME with two different phrasings for the same general decision point, one more neutral and one more hostile to a ‘yes’ response.

### DESCRIPTION OF THE DRAWINGS

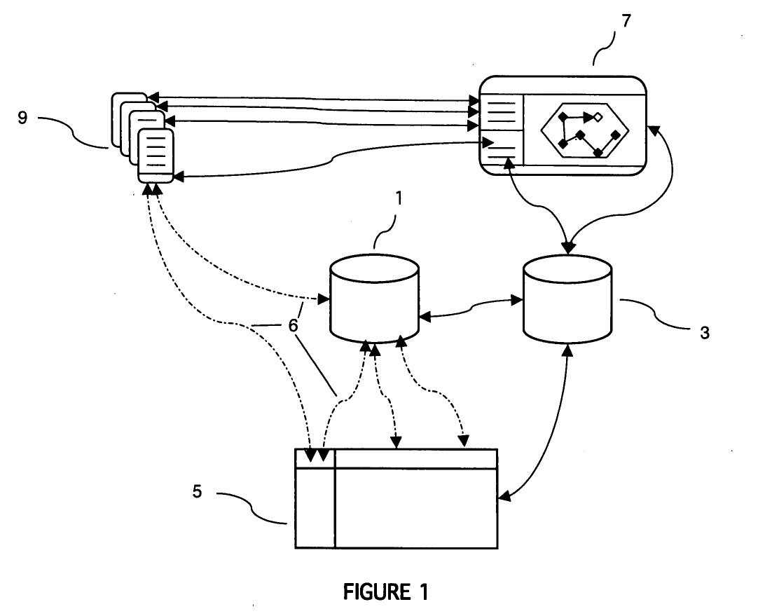

FIG. 1 shows the hardware elements and their connections (voice telephony by dashed lines, data telephony by solid lines) which comprise the architecture for the DDME and its operation. A datasource of possible communication links [1] is compared against both a distinct datasource of desirable qualities [3] and a datasource of potential Targets incorporating specific data records for each of their qualities [5]. A set of at least one Communications Manager (‘CM’) equipped with a computer [7] with a display and I/O devices for the CM, on which the DDME is running and through which the CM uses the DDME, controls a second set of at least one Field Operative equipped with a specific and distinct handset [9]. As a Field Operative establishes a live link with a particular individual Target [6], this effects an interactive link between that Field Operative's handset [9] and the computer used by the Communications Manager [7]. The Field Operative and Targeted Individual progress through the dialogue using the handset, and the Communications Manager uses the real-time interactions between the Field Operative and Target to proof out the fidelity of the data in the respective datasources and specific data record for the live-contact Target [1, 3, 5], while also directing the Field Operative, using the link, through the process of the interaction according to the goals set by the Communications Manager as determined by the live responses of the Target within the constraints of the set of possible queries contained in the datasource of desirable qualities [3] and the constraints on overall management of the set of Field Operatives contained within the computer. The results of each step of the interaction are fed back through the handset [9] to the computer [7] and data record of the Target [5] to ensure real-time fidelity of the data, while the computer also analyzes the aggregate collected responses from the set of handsets [9] stored in the datasource of desirable qualities, which the CM uses to manage, and update and adapt the DDME and all instantiations of the dialogue then in communication with the computer [7].

This same architecture has a second active use. At any given point in time out of a set of possible communication links contained in that datasource [1], a number of connection attempts will fail to produce a live link as the Target may be busy, absent, have left only an automated response, or the record may be incorrect. The datasource of possible communication links can drive at least as many simultaneous attempts to effect a live link at any point in time as there are uncommitted Field Operatives with handsets [9], and as many more as predictably will not result in a completed live link between a Target and a Field Operative with a handset [9]. Once a live link is connected, the interaction and data fidelity assurance are monitored, controlled, and recorded as noted above.

The same architecture has a third active use; in the event a communications link cannot be established between the tuple of Field Operative and Targeted Individual and the DDME on the CM's computer, the Field Operative's handset uses the last recorded instantiation of the dialogue and records the data experienced by the Field Operative including that received from the Targeted Individual; which data is stored along with the context of receipt and subsequently sent to the DDME when the communications link is restored.

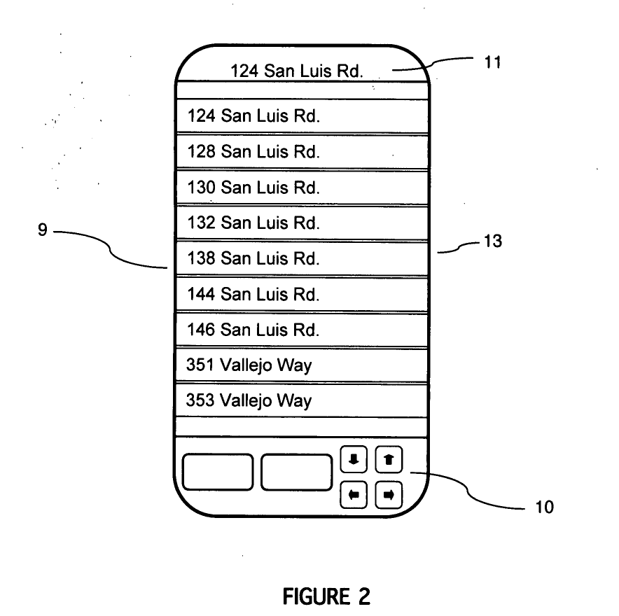

FIG. 2 shows the display and controls of a specific handset [9], with the hardware and application (software) controls [10] at the bottom and the current target identification [11] and active list of potential target identification designators [13] (in this example, the targets are identified by particular addresses instead of personal names).

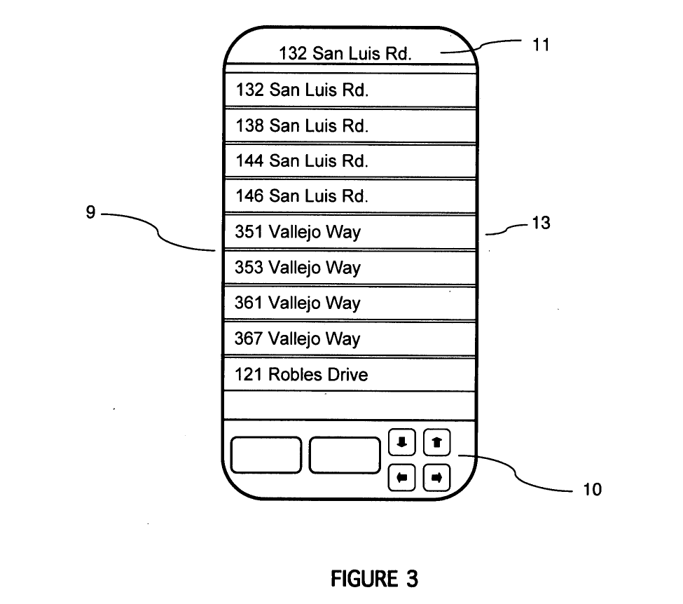

FIG. 3 shows the display and controls of the same specific handset [9] with the hardware and application (software) controls [10] at the bottom; as the Field Operative using the handset has made progress the current target identification [11] and active list of potential target identification designators [13] have been updated and changed.

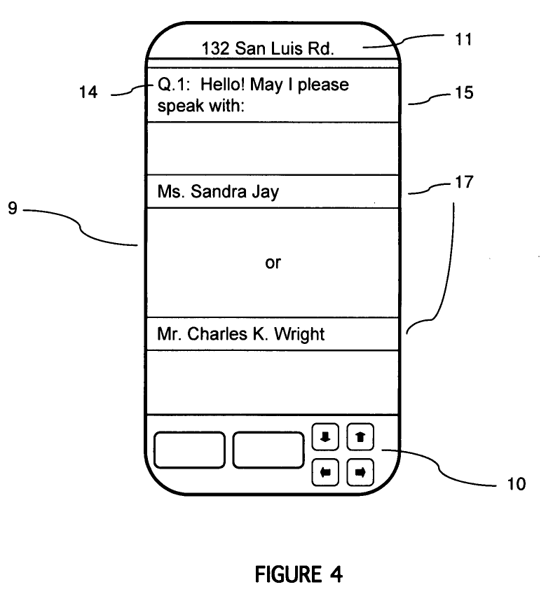

FIG. 4 shows the display and controls of the same specific handset [9] when a live communications link has been established with a current target, as identified by the current target identification [11]; and the display now both identifies the current state of the dialogue [14] and offers for the Field Operative a particular starting script [15] identifying the desired and specific individual(s) who are the sub-target for the continued live link by a more particular and detailed specification [17] (in this case, their name).

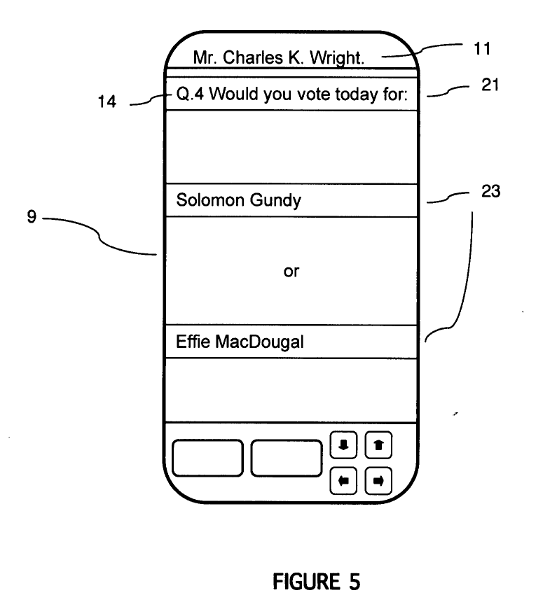

FIG. 5 shows the display of the same specific handset [9] during the progress of communication between the Field Operative and a specific individual, as identified by the live-updated current target identification [11], with the display showing a specific state of the script with a decision point [21], and the set of applicable responses [23] provided from the Communications Manager's computer (not shown).

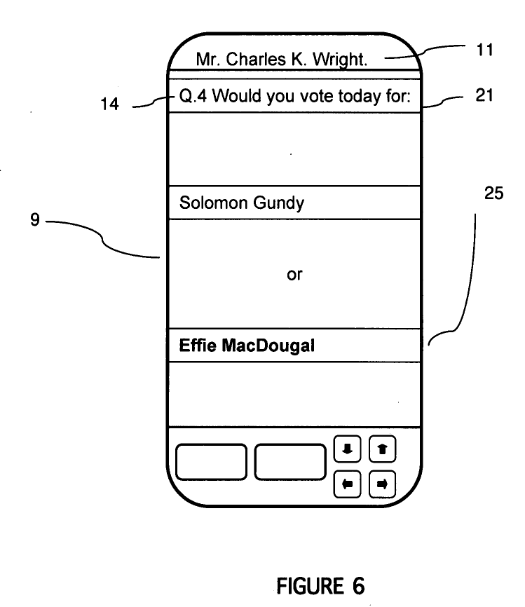

FIG. 6 shows the display of the same specific handset [9] upon the entry of the Target's response [25] which is communicated to the Communication Manager's computer (not shown); the selected response being visibly differentiated on the display from the non-selected response.

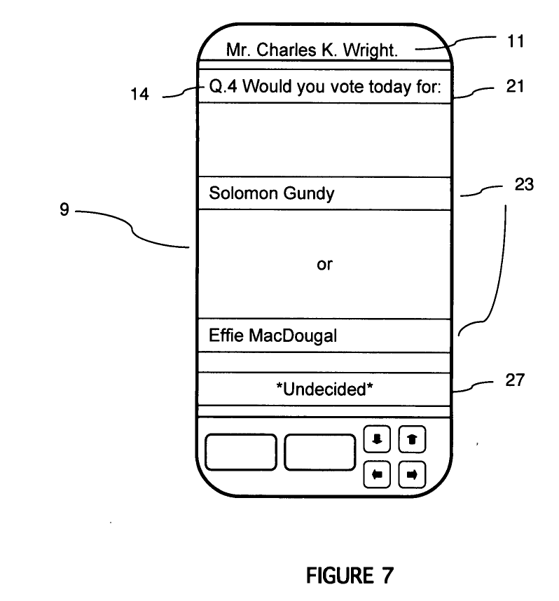

FIG. 7 shows the display of the same specific handset [9] upon the entry by the Field Operative of a Target's response [27] which is not a member of the set of applicable responses [23], with the non-member response being communicated from the handset [9] to the Communication Manager's computer (not shown).

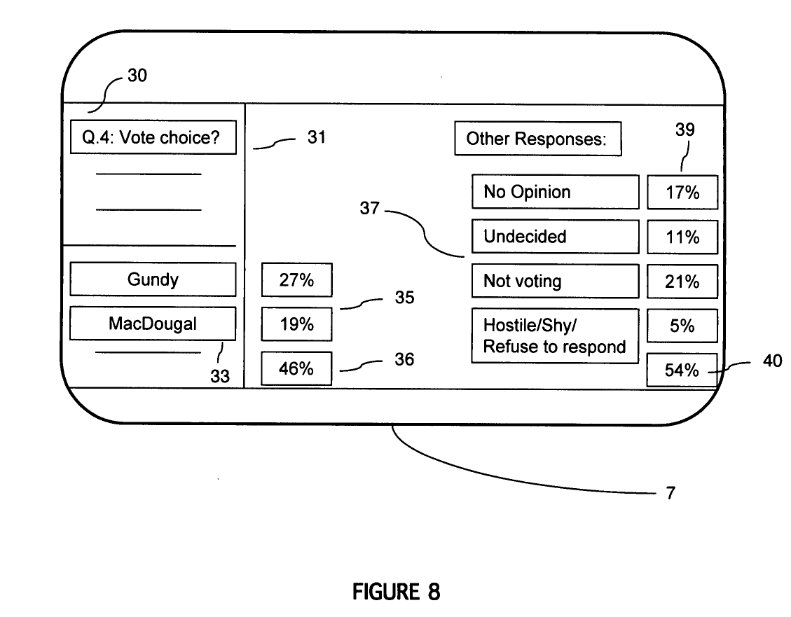

FIG. 8 shows the display of the Communication Manager's computer [7] aggregating from the set of Field Operative handsets the responses from the set of Target Individuals presently or previously contacted. The aggregate responses are displayed proportionally (in this case, textually with percentage valuations; in an alternative embodiment this may be graphically or map geo-locationally displayed). The aggregation includes both anticipated and pre-set choices (the ‘applicable responses’) and (more importantly) the most common exceptions encountered to the set of applicable responses, thereby displaying for an identified, specific state of the dialogue [30] with a decision point [31], the set of applicable responses [33], the proportion of actual responses for each element thereof [35], and the aggregated exceptions [37] and proportion of actual responses fitting such exceptions [39], which data is also transmitted to the datasource of desirable qualities [3] (not shown).

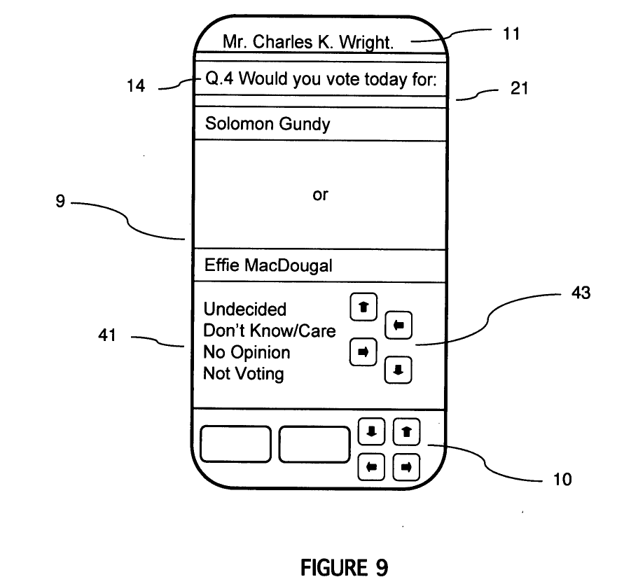

FIG. 9 shows the display of each Field Operative's particular handset [9] for the specific state of the dialogue [14] with the specific decision point [21], updated by the Communications Manager through his computer (not shown) to incorporate a modified set of exceptions [41] and, for each subsequently encountered Target's response that matches a member of the modified set, the specific handset control to select and enter that match [43] (which is no longer an exception).

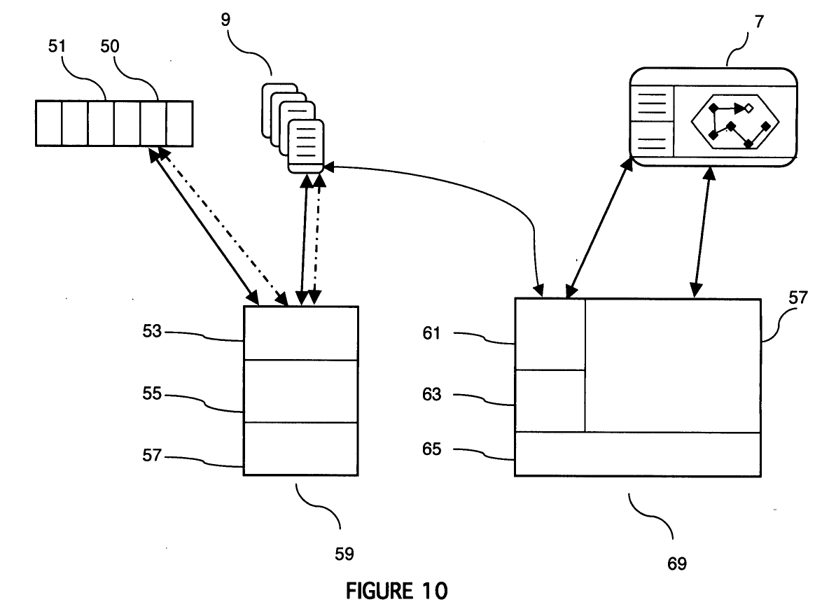

FIG. 10 shows the information-related interconnectivity of the system; when a set of Field Operatives [9] are engaging and actually interacting with a set of Targets [51], for each specific Field Operative who is in live contact with a particular identified Target [50] both voice and data are communicated through a Telephone Access Layer (TAL) [53] running on top of a Free Switch Application Layer (FSAL) running on top of a ‘backend’ communication server(s) [57], which together comprise the Telephone Services (TS) [59]; while the specific data validated and generated through this live contact goes from the specific Field Operative to a Data Access Layer (DAL) [61], running on top of an Application Engine (AE) [63], which engages both the Core Datasource (CS) [65] specific to the communications effort and the Analytical Function Engine [AFE] [57], all of which form the Analytical Server [69]; all of this happening as the dynamic transfer of the received, specific data validated and generated through this live contact is communicated from the DAL [61] to the Communications Manager's computer [7] along with the combined analytical results from the AFE [67]. The Communications Manager can then effect dynamic 435 changes to the next interactive step in the script which will flow from his computer [7] to the AFE [67] and through the DAL [61] to the Field Operative's handset [9], which can be immediately used by the Field Operative as the next, dynamically and interactively organized, step in the communication with the specific Target [50], with the same dynamic change being subsequently used by all Field Operatives whose handsets [9] are updated with the change as they individually reach the same ‘state conditions’. As in FIG. 1, voice telephony is indicated by dashed lines, and data telephony by solid lines.

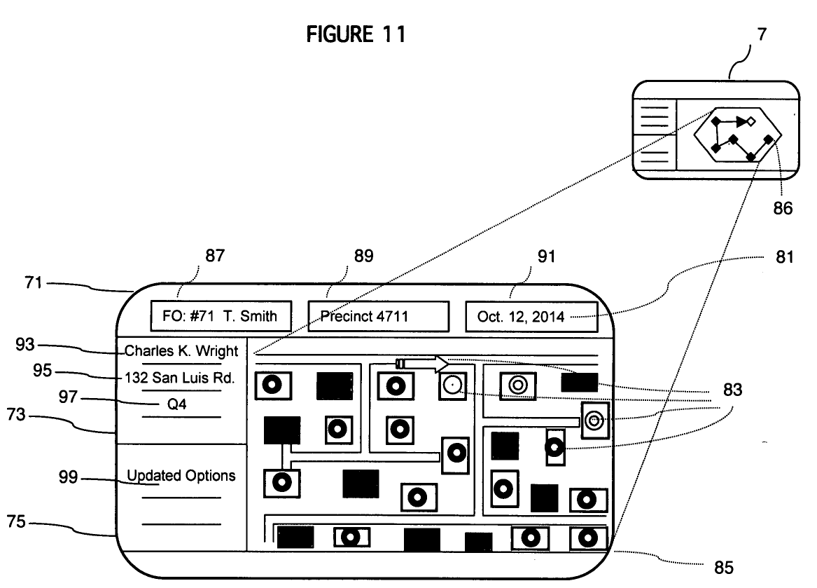

FIG. 11 shows an exemplar of the interactive dialog control used by the Communications Manager to supervise and as desired dynamically adjust the process of communication for either a specific Field Operative or, through modification of the DataStore (not shown) the set of Field Operatives, depending upon the response at a specific decision point. Accessible and visible to the Communications Manager through the display on his computer [7] are the contextual data of his current focus [71], the source data from the datastore which was used by the Field Operative to effect the live contact [73] and the Communications Manager's viewpoint of the received data [75] from this specific interaction.

The display incorporates and used any or all of text [81], graphics (indicating current position of the Field Operative with an arrow, locations contacted already with filled, and those not contacted with empty target markings, and current target location with an open target marking [83]), and maps, in large scale [85] and small [86]. The contextual information for the Communications Manager can identify the particular Field Operative [87], his operating area [89], the date [91], the intended specific Target [93], the validating and confirmed Target identification used to find the specific Target [95], the actual live location of both Field Operative and Target [97], and the current state of the communications dialog [99] for that specific Field Operative.

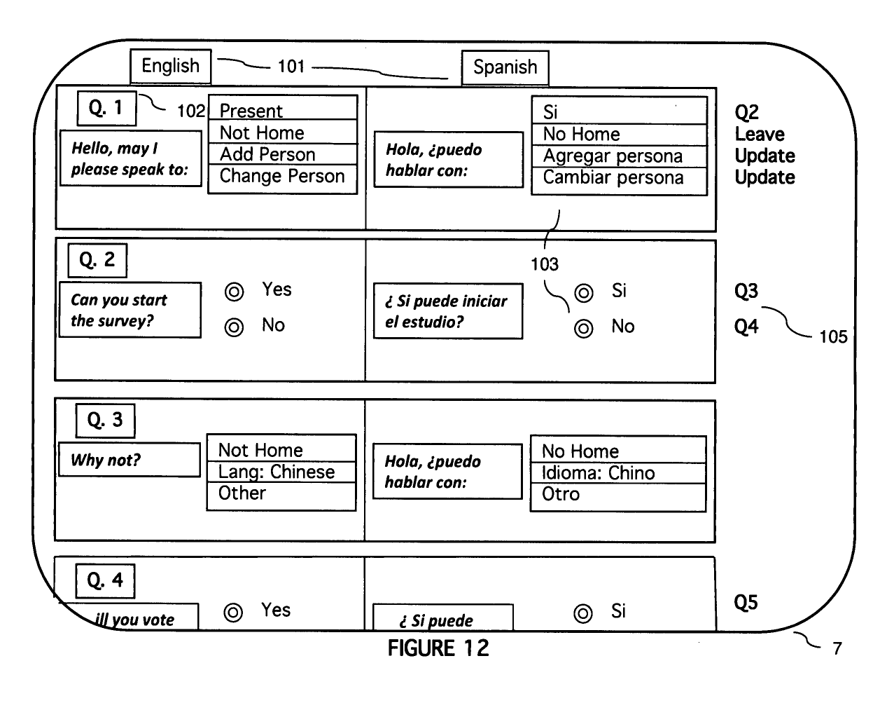

FIG. 12 shows an exemplar of the communications dialog oversight and state operations used by the Communications Manager to supervise and as desired dynamically adjust the process of communication for either a specific Field Operative or, by modifying the state logic of the dialog, the set of Field Operatives. For each particular state in the dialog the combination of query and set of acceptable responses is shown, with the Communications Manager able to review these within the set of operative languages for each specific, denoted language [101]. A variety of controls (shown as exemplary are menu selection and radio buttons [103]; but also possible are slider bars, open-text, icon selection, and other Graphical User Interface icons and tools known to the art, including those operating by touchscreen, key entry, and elsewise) as they will appear on a Field Operative's handset (not shown) govern the transition from the current state to the next state of the dialog. The specific transition state is identified for each selection [104].

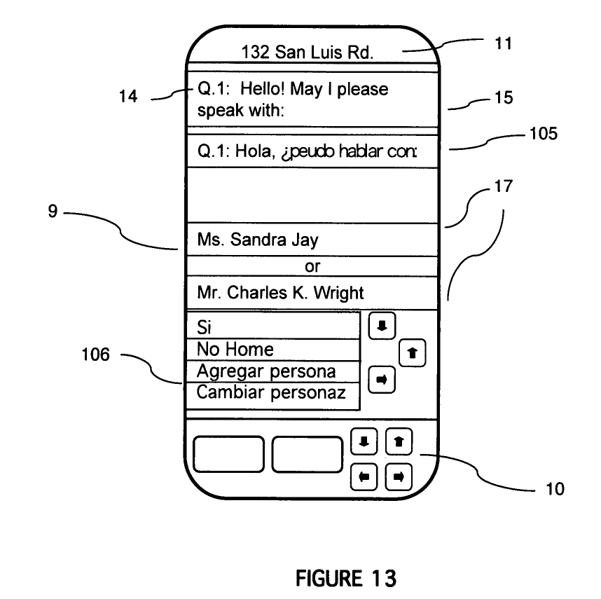

FIG. 13 shows the display and controls on a handset [9] when a live communications link has been established with a current Targeted Individual, as identified by the current target identification [11]; and the display now both identifies the current state of the dialogue [14] and offers for the Field Operative a particular starting script [15], in paralleled languages (the second one of which [105] the Field Operative does not share or wishes support with), identifying the desired and specific individual(s) who are the sub-target for the continued live link by a more particular and detailed specification [17] (in this case, their name). To additionally support the Field Operative, a set of possible responses in the paralleled language, along with the specific control to be used to indicate each [106], is also provided.

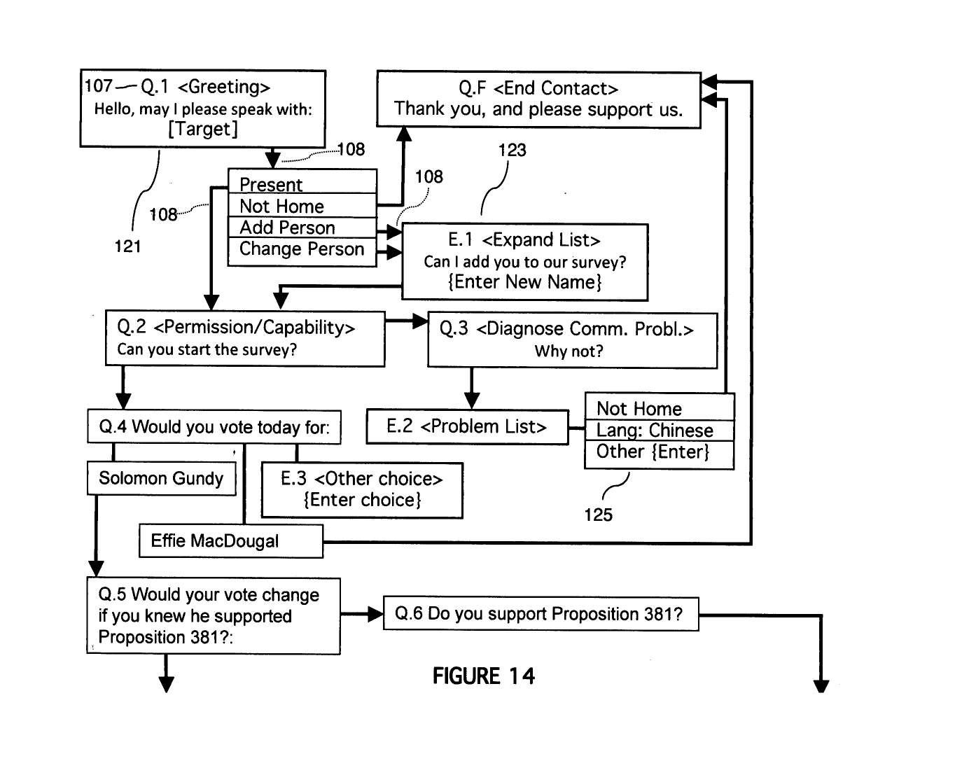

FIG. 14 is a simplified example of a dialogue. This one has three basic state types, Questions (denoted by a ‘Q’ followed by a number, to uniquely identify them) [121]; Exceptions (E, similarly denoted) [123]; and Responses [125]. Responses are not denoted as such, but match the entry possibilities shown to on the display of the handset used by the Field Operative when the preceding Question State is reached (as seen in FIG. 13) and individually constitute the triggering condition for a transition to a next sub-state. The 492 direction of the arrow indicates the difference between a ‘Yes’ and ‘No’ when these lead to different sub-states. In this example for state Q.1[107], there are only three target sub-states [108], even though there are four possible Responses [109]. 2 of the Responses are not unique and lead to the same target sub-state, so there are only 3 triggering conditions (1 per possible target sub-state).

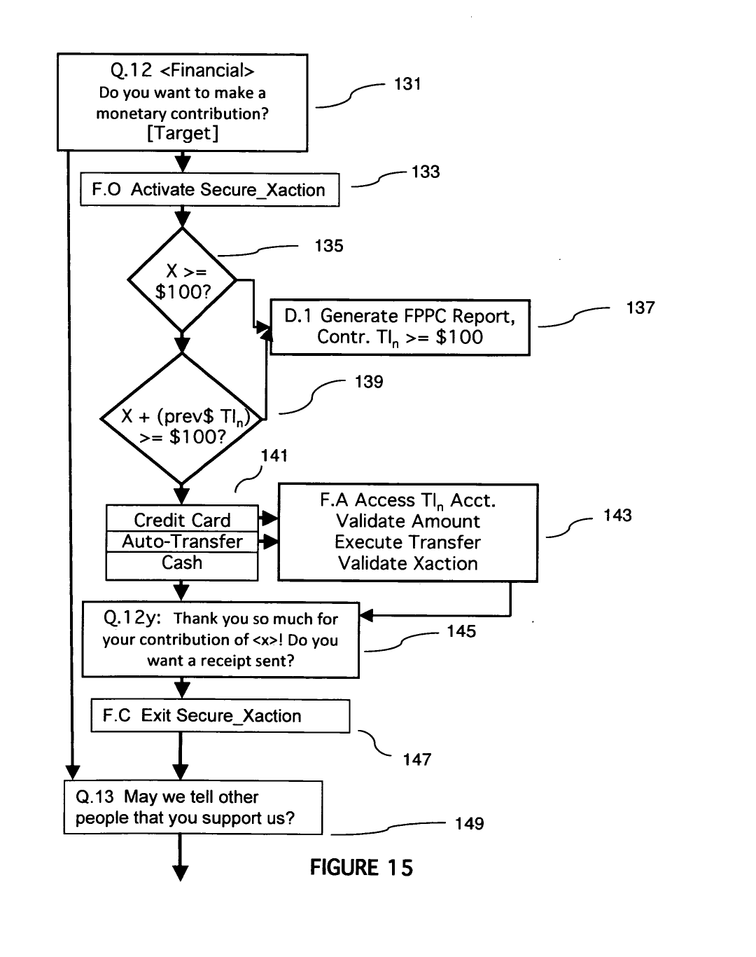

FIG. 15 is a simplified example of a financial exchange sub-state (which generally will comprise an organized sub-set of sub-states; in this case, [133-147]).

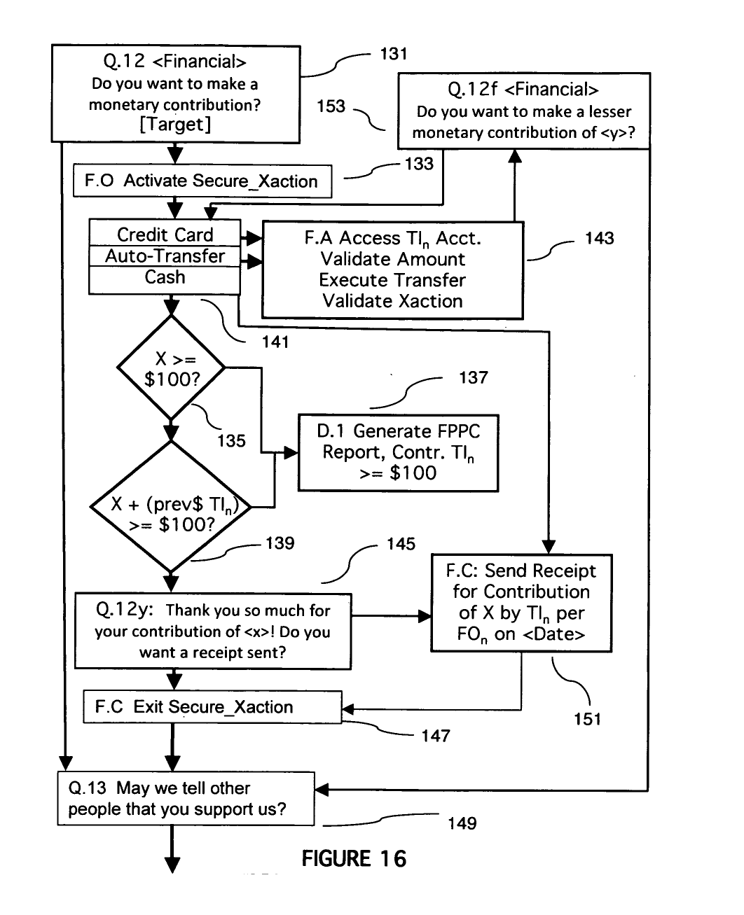

FIG. 16 is a simplified example of the financial exchange sub-state shown in FIG. 15 after it has been dynamically modified by the Communications Manager.

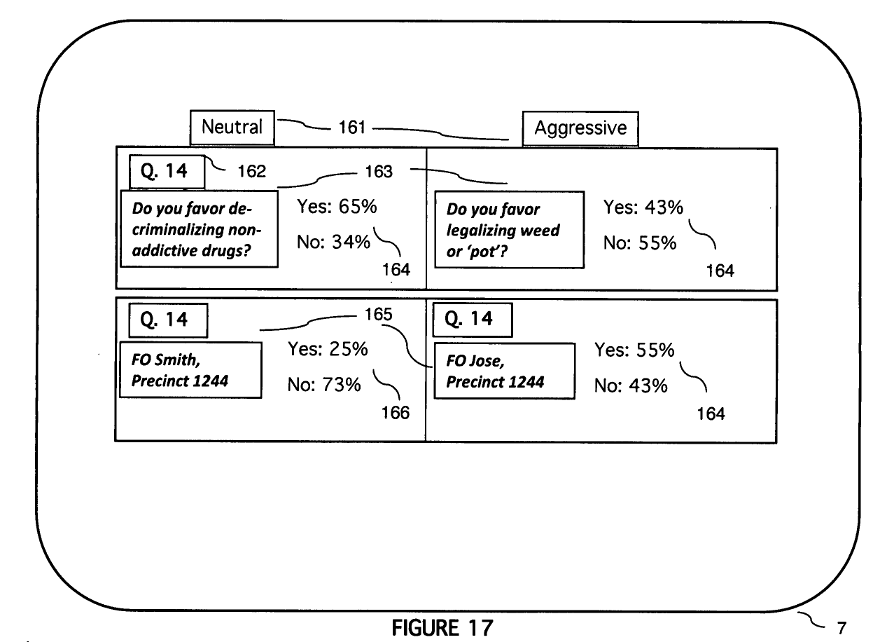

FIG. 17 is a simplified example of the Communications Manager using the DDME with two different phrasings for the same general decision point, one more neutral and one more hostile to a ‘yes’ response.

### DETAILED DESCRIPTION

When an individual (such as a candidate for a political office, or a manager for an artificial entity such as a corporation, partnership, cooperative, or joint venture) seeks to effect communication with multiple others, this individual (a ‘Communications Manager’) wants his communication effort to be effective; he wants it heard, not merely distributed, observed, or listened to. The Communications Manager want to evoke from each Targeted Individual and of the set of a truthful response, a useful response, a financial commitment, or an action. When the same individual communicates through a dialogue with multiple parties, then communicating the core concept of the dialogue is most effective if the communication process is dynamic (able to change assumptions to match reality experienced during the process), adaptive (responsive to decisions and responses), and interactive (in real-time matching that range of sub-communications which best modulate the presentation and reception according to the effects and differing capabilities of each party engaging in the dialogue). For a non-interactive dialogue is a lecture; a non-adaptive dialogue is a sermon; and a static dialogue is boring, ineffective, and already out-of-date—none of which are effective communications in a modern world with short attention spans and little patience. Even the simplest dialogues, constituting a single question and open range of answers, or two-step leading series (e.g., “Do you support Congressman Barney Frank?”, or “Would you like to switch your energy supplier? To a solar-based, lower cost one?”), incorporate an interactive exchange.

Although there are separate elements specifically described herein as ‘handsets’ and ‘computer’, for each, any hardware platform suitable for performing the processing described herein for the functionality embedded in the invention as described, is suitable for that use with the invention. A ‘handset’ is something carriable by a single hand which will incorporate a display, controls, processing and memory and both voice and data communications functionalities; and a ‘computer’ could have one or more electronic processing units, including both a central processing unit (logic unit) and a subordinate graphical processing unit (display unit). In the preferred embodiment each handset is a smartphone that each become elements of a distributed computing network, and the ‘computer’ can be either a specific individual smartphone which contains the centralizing data aggregation, dialogue management, instantiation authorization, and data analytic functionalities, or a larger computer (laptop or desktop, even workstation or mainframe).

Some of the above-described functions may be composed of instructions, or depend upon and use data, that are stored on storage media (e.g., computer-readable medium). The instructions and/or data may be retrieved and executed by the processor. Some examples of storage media are memory devices, tapes, disks, and the like. The instructions are operational when executed by the processor to direct the processor to operate in accord with the invention; and the data is used when it forms part of any instruction or result therefrom.

The terms “computer-readable storage medium” and “computer-readable storage media” as used herein refer to any medium or media that participate in providing instructions to a CPU for execution. Such media can take many forms, including, but not limited to, non-volatile (also known as ‘static’ or long-term') media, volatile media and transmission media. Non-volatile media include, for example, one or more optical or magnetic disks, such as a fixed disk, or a hard drive. Volatile media include dynamic memory, such as system RAM or transmission or bus ‘buffers’. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes.

Transmission media include coaxial cables, copper wire and fiber optics, among others, including the wires that comprise one embodiment of a bus. Transmission media can also take the form of acoustic or electromagnetic waves, such as those generated during radio frequency (RF) and infrared (IR) data communications.

Memory, as used herein when referencing to computers, is the functional hardware that for the period of use retains a specific structure which can be and is used by the computer to represent the coding, whether data or instruction, which the computer uses to perform its function. Memory thus can be volatile or static, and be any of a RAM, a PROM, an EPROM, an EEPROM, a FLASHEPROM, any other memory chip or cartridge, a carrier wave, or any other medium from which a computer can read data, instructions, or both. I/O, or ‘input/output’, is any means whereby the computer can exchange information with the world external to the computer. This can include a wired, wireless, acoustic, infrared, or other communications link (including specifically voice or data telephony); a keyboard, tablet, camera, video input, audio input, pen, or other sensor; and a display (2D or 3D, plasma, LED, CRT, tactile, or audio). That which allows another device, or a human, to interact with and exchange data with, or control and command, a computer, is an I/O device, without which any computer (or human) is essentially in a solipsitic state.

A Communications Manager will need a number of interacting elements (hardware, as shown in FIG. 1) to effect multiple (serial and parallel) communications. Each communication will be used to effect a dialogue, which will comprises a set of sub-states and transition linkages. (These can be as simple as: Tried contact using identified link; Failed.) The Communications Manager will need a datasource of possible communication links [1] (e.g. a telephone directory, an address directory, a marketing list) in which each entry identifies a specific, potential Target Individual (most commonly by name). This datasource of possible communication links [1], with individual data records therein having both identifying information as to a Targeted Individual potentially within the set of Targeted Individuals, and information enabling a communication link to be effected with that specific Targeted Individual, can be expected to contain errors and gaps, as it represents an abstract model of the real world; and even if the data is correct, at the time a communication link is tried there may be no one at the other end ready to receive the communication.

The Communications Manager will also need a distinct datasource of possible Target Individuals, with individual data records therein having both identifying information as to a specific potential Target Individual and about any set of qualities or categorizations (e.g. age or other demographic details, occupation, membership in a specific and targeted organization) recorded about that specific Target Individual, [3] which indicate that a communication effort is desired and thus a dialogue worth attempting. Again, this datasource can be expected to contain errors and gaps which the Communications Manager will wish corrected and filled if live contact is made.

Each of the above datasources will, for a given communication effort, obtain and use specific data specific and unique to the Target Individual whom the communications outreach is being made to, and link with that data record the result(s) of the communications effort in a specific data record for that particular Target Individual. The DDME will create or use (if one is provided) a Core Datasource (‘CS’), comprising a selection of data records [5] combining, for each such data record, the information enabling a communication link to be effected with a specific Targeted Individual and identifying information as to a specific potential Target Individual and information as to the specific set of qualities or categorizations which indicate that a communication effort is desired and thus a dialogue worth attempting. This selection can be imported into or created from scratch by the DDME and can also be managed, updated, and changed by the DDME, and will be modified to ensure fidelity between the reality of the live communication and interaction with the Targeted Individual experienced by a Field Operative and communicated through his handset [9], and thus limit, even preferably prevent, useless or counterproductive repetition.

Because the DDME, in the preferred embodiment, is interactive and allows dynamic modification of the datasource(s), it is very different from the great majority of the prior art. Although the DDME is capable of using pre-existing data records and datasources (in many forms, be these lists or tables), it is not a ‘list-processing’ engine; for, since it can start from scratch and build up not just the data, but the classification(s) and category(ies) through the information sent from the set of handsets [9], it is better described as a ‘no-list’ processing engine. It can create its own data collection, or augment those provided to it.

The DDME will also contain the dialogue which is to be entered into and interactively communicated with the Targeted Individuals by a Field Operative in a live, direct contact.

The Communications Manager will use a computer with processing capacity, memory (both long-term and active or ‘Random-Access’), a display, and Input/Output hardware [7] to access, monitor, analyze, and use the set of communications attempted and effected through the DDME. Each specific, individual communication occurs between a Field Operative with a handset [9] that is obtains live, real-time, and interactive contact and exchange of views with a Targeted Individual. Whenever a Field Operative enters into a live, real-time, and interactive communication with a Targeted Individual this forms a tuple (FOₙ; TIₙ). Each element within a tuple can be assigned any of the respectively known attributes (native language, age, ethnicity, educational group, income group . . . ) depending on the record and analytical complexity limits set by the Communications Manager and data constraints of the several datastores.

The DDME will further comprise a plurality of handsets, with each Field Operative having and using a handset [9] which contains an instantiation of the dialogue, with that instantiation being the most currently-updated version communicated through the DDME since the Field Operative logged in. The display of the handset allows the Field Operative and Targeted Individual to see the current sub-state of their tuple's shared instantiation, and the memory of the handset stores the data received (i.e., the responses and volunteered additional information from the Targeted Individual, plus that experienced and entered by the Field Operative) through the process of interaction. This display is that on which the dialogue's most current sub-state can be shown to the Field Operative and Targeted Individual, with controls enabling the input from the Targeted Individual to be entered into the handset to effect the transition to the next sub-state. In the preferred embodiment each handset is capable of any set of voice, visual, and data communications. The DDME will also incorporate a datasource of Field Operatives comprising data as to their particular qualities, duties, performance, handset, contacts, current status and location, and efforts.

If the communication link (data or voice or both) is functioning and the bandwidth is available, the data received and input through the handset is communicated to the DDME and its datasources; but if the communication link is not available, then not only is the data received stored, but the context as it exists at the time of reception is linked and stored with it. Whenever the communication link is restored then the data which has been kept on the handset is transmitted, just as any changes to the dialogue, or to the Field Operative's goals or functions, entered by the Communications Manager will be sent through the DDME.

The Communications Manager uses his computer to control the use of the datasource of possible communication links [1] and both a voice telephony call to the handset [9] being used by a specific Field Operative in live, interactive contact with a particular Targeted Individual, and a data telephony exchange between the handset [9] and, through the Communications Manager's computer [7], the datasources. This enables real-time, interactive, fidelity between the record(s) and the real world experience, so the immediately-modified record [5] now contains an updated record. The Communications Manager can monitor this interaction to serve as a one-step-removed validation monitor, which can help limit (although not entirely avoid) an effort by either the Field Operative or the Targeted Individual, or both together, to falsify the record of their interaction.

The computer further contains a dialogue management tool (or set of subordinate tools which collectively comprise the same functionality) which enables and allows the CM to construct, monitor, modify, or delete the structure of the dialogue, including any set of its sub-states, conditions of entry and actions upon exit of any state, actions upon any transition between one sub-state and the next (including final exit from the dialogue).

In FIG. 2, the display of a particular Field Operative's handset [9] indicates the current identification being used to denote the next specific Target Individual [11]—in this drawing, it is a specific street address, one of a list of specific street addresses [13] partially shown on the display. The controls [10] would allow movement through the list, selection of an individual entry, or operation of other aspects of the handset (not shown).

Because the handset [9] for each Field Operative contains the dialogue as of the time of the last connection with the Communications Manager's computer, and can both store and transfer data collected from instantiations of the dialogue experienced with a plurality of Targeted Individuals during a period of non-communication when a subsequent re-connection is established, each Field Operative, and the Communications Manager, can use the DDME without requiring each or every handset to maintain a continuous connection, link, or signal. Thus the handset and DDME can be used even in areas where continuous telephonic or web connectivity are not assured or frequently interrupted—rural areas, rugged wild areas, and densely-built urban areas (particularly apartments and condominiums). When connectivity is re-established between a handset and the computer, the stored instantiations and their time-and-location context which was also stored are communicated to the Communication Manager's computer.

FIG. 3 shows how the handset's display changes as the Field Operative moves to a next possible contact, for both the current identification [11] (specific street address) and list of succeeding contacts [13] change to reflect the Field Operative's progress.

In FIG. 4, the handset now shows the current identification [11] (street address) where a live contact has been initiated with an individual. Not only does the handset identify for the Field Operative the present state of the dialogue [14], it also prompts the Field Operative with the script for his use at this state of the dialogue [15], also providing more particular information as to the specific individuals sought as their names [17] are displayed.

In FIG. 5, the handset now shows the particular Targeted Individual with whom the Field Operative is in live communication with, using—as recommended by Dale Carnegie and others—for the current identification, their name [11]. Again the handset identifies the present state of the dialogue [14] (changed from that shown in FIG. 4), which is a decision point between two options [23].

In FIG. 6, the handset now shows the response selected by the particular Targeted Individual [11] at the current state of the dialogue [14], indicating that of the two options, the Targeted Individual has selected the second [25].

In FIG. 7, the handset now shows that the particular Targeted Individual with whom the Field Operative is in live communication with [11], at the present state of the dialogue [14], has responded to the decision [21] with something other than the two presented choices [23], and the Field Operative has entered into the handset this new and unexpected response [27].

In FIG. 8, the Communications Manager has been using his computer [7] to monitor the set of Field Operatives who are, or have already been through, the state of the dialogue experienced by the specific Field Operative at the time of contact shown in FIG. 7. The Communications Manager can see for the identified state of the dialogue [31] both the two choices built into the script [33] and the to-date percentage of responses for each [35]. At the same time the Communications Manager can see a list of exception responses that have been recorded and communicated from the Field Operatives, and the to-date percentage of total responses [39] these represent. Less than half of the Targeted Individuals are accepting either of the presented choices [36] and over half are insisting on some exception [40].

This allows the Communications Manager to change the dialogue, its script and structure, dynamically, adapting to the reality of preferred set of available responses, which change is immediately available to each Field Operative. This is shown in FIG. 9, where each Field Operative who reaches that dynamically altered state of the dialogue [14], now has four new alternative options [43], selectable by the handset's controls [10], presented, making the experienced range of most probable responses available to each Field Operative and Targeted Individual who subsequently encounter that specific state of the dialogue.

A principal particular advantage of the current invention is that it enables the Communications Manager to validate the accuracy (or lack) of both each possible communications link, and of the communications effort using that link. This establishes a real-time fidelity of accurate representation between the ‘record’ and ‘reality’, as it occurs. This is effected through the combination of data a telephony communication linkages as shown in FIG. 10. Turning the data from a set of Field Operatives [9] who are engaging and actually interacting with a set of Targeted Individuals [51], for each specific Field Operative who is in live contact with a particular identified Target Individual both voice and data are communicated through a Telephone Access Layer (TAL) [53] running on top of a Free Switch Application Layer (FSAL) running on top of a ‘backend’ communication server(s) [57], which together comprise the Telephone Services (TS) [59] from the handset. At the same time, the specific data validated and generated through this live and interactive contact goes from the specific Field Operative's handset [9] to a Data Access Layer (DAL) [61], running on top of an Application Engine (AE) [63], which engages both the Core Datasource (CS) [65] specific to the communications effort and the Analytical Function Engine [AFE] [57], all of which form the Analytical Server [69], which is managed by and interacting with the computer [7] used by the Communications Manager. The received, specific data validated and generated through this live contact is communicated from the DAL [61] to the Communications Manager's computer [7] along with (but separable, and separably displayable from), the combined analytical results from the AFE [67]. The Communications Manager can then effect dynamic changes to the next interactive step in the script which will flow from his computer [7] to the AFE [67] and through the DAL [61] to the Field Operative's handset [9], which can be immediately used by the Field Operative as the next, dynamically and interactively organized, step in the communication with the specific Target [50]. Also, the same dynamic change will subsequently be effected for all Field Operatives whose handsets [9] are updated with the change as they individually reach the same ‘state conditions’, i.e. the same sub-state in the overall dialogue's DFA. As in FIG. 1, voice telephony is indicated by dashed lines, and data telephony by solid lines. The Analytical Function Engine can take the data from any set of the handsets, Core Datasource, datasource of possible communications links, distinct datasource of possible Target Individuals, or datasource of Field Operatives, and perform comparative, aggregate, deconstructive, mathematical, and other functional operations thereon, as determined by the CM within the computer's then-current capabilities, whether using software within the DDME or external thereto.

A second particular advantage of the current invention is that it enables the Communications Manager to analyze not just the effectiveness of each specific communication, but that of the aggregated communications using the current dialogue. This analysis can distinguish between a flaw arising from the information as one coming from a problem with the communications link, one arising from a discrepancy between the data record representation of the Targeted Individual and his (or her) current real quality(ies), or one arising from an error by the Field Operative' use of the handset or progress through the dialogue. The analysis of the Communications Manager of the entire set of live interactions can further identify and dynamically correct a flaw (or omission) in the design of the dialogue as a whole, as will be exemplified below.

For example, as shown in FIG. 11, the display on the computer [7] used by the Communications Manager can be used to disclose whether a particular Field Operative is in live contact with the Targeted Individual at the latter's address in the data record for that specific person from the datasource of possible TI's, by displaying not just two distinct and separate identifiers (name [93] and street address [95]), but the physical location of the specific Field Operative [87] with a different and orthogonal pair of separate and distinct identifiers (the TI's precinct [89] and the FO's physical location, displayed on the map of the FO's current route [85]).

A third principle advantage of the preferred embodiment is that the Communications Manager can use a constructed dialogue as a structure which can be adapted to overcome particular limitations—most particularly, in the example shown in FIG. 12, that of a lack of a shared language between any Field Operative who speaks only English, and Targeted Individuals who do not but can read (or hear) only Spanish. No longer need the Field Operative(s) be entirely without recourse when he(they), personally and individually, do not speak the language of a Targeted Individual. While normally the displayed text on the Field Operative's handset will be in a common language shared by both the Field Operative and the Targeted Individual, in a multi-language-group polity this cannot always be assured. Because the text shown on the display of the handset will be expressed within a known sub-state of the dialogue, what is needed is not full translation capability, but a prepared and validated translation for that specific expression. As the preferred embodiment includes means for translation of text comprising an expression which is part of an exchange in a first language into an equivalent expression in a second language; input means for the CM to select text comprising an expression in a first language to be so translated; storage means for the DDME to retain both the equivalent expression in a second language and the pairing of the translation; and, output means for the DDME to pair the translated text within any sub-state of the dialogue where the translated text comprising an expression exists, with the translated text, within the display of that sub-state; the CM can manage the dialogue to effect what appears to be ‘open-ended’ translation, while only actually affecting and then effecting those transitions and states of the dialogue which require translation. When designing the dialogue, the Communications Manager can set up for review through the display on his computer [7], the dialogue with the exact parallel, validated by a qualified native speaker for the respective languages [101], lined up and displayed for each sub-state of the dialogue [102] of the query-and-response-choices [103], which display indicates also what state each particular response will transition to [104]. Different types of controls (menu, radio button, open-ended text entry) can be incorporated into the dialogue as designed with the logic and connectivity being shared by all Field Operatives while simultaneously being accurately correlated with the particular language's expression of the question-and-responses for the parallel sub-state of the interaction. Expanding the entire dialogue to a new language does not require reconstruction from scratch; but more importantly, as the preferred embodiment lets the parallel language representations be shown on the Field Operative's handset, the two individuals in live interaction can step through the dialogue together with each using his native, or perhaps only, language, and effect a meaningful progression through the dialogue. As a further extension of the preferred embodiment the handset, because it incorporates voice telephony, can connect through the Telephone Services (FIG. 10, [59]) to a live speaker of the Targeted Individual's specific language as displayed on the handset and have that individual provide a vocal recitation of the language's text for the state of the dialogue as currently displayed on the Field Operative's handset, which simultaneously serves to educate the Field Operative in the language of the Targeted Individual, as used in the dialogue. This ability to use the co-displayed language options using both the language of the Field Operative and actual Targeted Individual can overcome a linguistic barrier which may be inadequately or inaccurately reported through the datasources and specific datarecord; and the ability to analyze and aggregate the experiences and interactions of the entire set of Field Operatives, and dynamically adapt the dialogue in response thereto, make the transition to new and different language groups a far more manageable step as the necessary linguistic expertise, which presumably is scarce, can be centralized through the Communications Manager's computer rather than having to be not just in the field, but literally walking along with every Field Operative and present at each (often simultaneous) contact.

FIG. 13 shows a handset activated for a language-limited Field Operative, with the paralleled text [15, 105] of the question, and a specific response set tying which of the controls [10] should be used with each specific member of a set of responses in the paralleled language [106] presented to the Field Operative from the Targeted Individual.

A third particular advantage of the current invention is that it enables the Communications Manager to use the analysis of the aggregated communications efforts to change the structure of the dialogue, its script elements, or its transitions, to more closely move the experienced dialogue between not just the current Targeted Individual and Field Operative being overseen by the Communications Manager, but all subsequent interactions which use the now-modified dialogue.

A fourth particular advantage is that it enables the Communications Manager to devise a dialogue before any effort is made to use it to communicate with a single Targeted Individual, to the best of his (or her) ability to think of the possible and sensible reasoning chains and boundaries of useful communication. This act of devising a dialogue will include identifying the core concept, obtaining a list of ‘Target Individuals’ who are to be contacted and engaged, classifying and obtaining qualities of the potential Target Individuals (direct and secondary, such as demographics) which might affect for good or for ill the process of communication in the dialogue; and considering the range of means to be used for measuring, recording, analyzing, and reacting to the actual experiences as communication efforts are made. A good Communications Manager will also take into account the qualities of the particular individuals who are engaging the Target Individuals on behalf of the organization, that is, the Field Operatives who make direct or live contact with each of the Target Individuals with whom the communication, the dialogue, is effected.

In devising a dialogue the Communications Manager will start with a model, or set of assumptions, about the set of Targeted Individuals, Field Operatives, and the process experienced by each pair of Field Operative and Target Individual through the structure and reasoning of the dialogue. This model will contain the goal of communicating the core concept through an ordered transition through some sub-set of a web of potential sub-states, each of which represents a single, or a limited sub-set, of the entire communication. For example a syllogism has at least three substates—those being two separate premises and a conclusion, with each premise sharing at least one term with the conclusion and at least one term with the other premise which is not necessarily in the final conclusion, as that non-shared term effects the reasoned transition from premises to conclusion. An example of such a syllogism is: (1) “All animals have four legs” [first premise]; (2) “All dogs are animals” [second premise], which when combined lead to: “All dogs have four legs” [conclusion].

Each step through a dialogue can be modeled as a state, with the transition between states representing an agreed-upon reasoning effort (whether logical or emotional). Modeling human interactions through pre-set scripts, or state-transition diagram dialogues, has been known to the art for decades; using a computer to contain and test the models (sometimes through Boolean, modal, or other logics; or simply through text storage) has also been known.

However, most human communication also incorporates process signals to let the parties mutually recognize whether information has been transferred and received, and whether the transferred information has been accepted, rejected, or held as indeterminate. Even the simplest syllogism, recited in reality, is not immune to the temporarily interruptive factor of a surprising and sudden loud noise (such as a jet takeoff), or a contextual cue that distracts the listener (such as a telephone ringing, or spouse interrupting). Also, effectively communicating dialogues must dynamically adapt to correct for unanticipated or over-simplified assumptions built into the original structure and process. (For example: P: “I just told you all dogs are animals.” R: “Yes.” P: “I told you all animals have four legs.” R: “What about snakes?” P, correcting: “Ah . . . all land-based animals have four legs.” R: “Yes.” P: “So all dogs have four legs.” R: “Since dogs are animals, and I agree land-based ones, then as all land based animals have four legs, I agree that dogs have four legs. What about those hit by a car or who had a leg removed by surgery?”)

Reality is always more complex, particular, and out-and-out ‘messy’ than any model; but a Communications Manager dealing with a set of dialogues (both serially and parallel engaged in) must monitor the interactions, store the exceptions, analyze the effectiveness, and re-adjust, dynamically and in real-time, according to the experience gained from the Field Operatives, to effectively communicate.

A dialogue that has been constructed can be called a ‘script’; however, the difference between the usual script, and a dialogue (as the term is used in this application), is that a script is fixed in content and order—question and the space for the response are predetermined and not responsive to the specific experience(s) of any tuple of Field Operative and Targeted Individual.

A dialogue as defined and implemented in the preferred embodiment of the present invention begins as an example of a finite state machine. FIG. 14 is a simplified example of a dialogue. It has three basic state types, Questions (denoted by a ‘Q’ followed by a number, to uniquely identify them) [121]; Exceptions (E, similarly denoted) [123]; and Responses [125]. Responses are not denoted as such, but match the entry possibilities shown to on the display of the handset used by the Field Operative when the preceding Question State is reached and individually constitute the triggering condition for a transition to a next sub-state. (As the arrows at the bottom of the Figure suggest, the dialogue continues through more states and transitions.) For each live interaction between a Field Operative and a Targeted Individual, their instantiation of the dialogue will at any given time be in only one, distinct, sub-state; and will transition from that only to the set of sub-states allowed within the dialogue, and will transition to the specific next sub-state dependent upon the exchange establishing the unique triggering condition for that specific next sub-state. As shown, in state Q.1[107], there are only three target sub-states [108], even though there are four possible answers [109]. 2 of the answers are not unique and lead to the same target sub-state, so there are only 3 triggering conditions (1 per possible target sub-state).

Transitions can represent logical, factual, authoritative, emotional, cultural, or personal-preference linkages (with the first three usually being described as ‘rational’, and the latter three as ‘rationalizing’) between an assumption and a conclusion. A dialogue can incorporate informational, argumentative, persuasive, and other state-transition conditions. The most effective communicators use dialogues that will incorporate information either previously known about, or interactively gained from, their Targeted Individual, and choices made by that same Targeted Individual, to adaptively persuade the Targeted Individual to move to and through those sub-states that reach the conclusion sub-state (or set thereof) preferred and sought by the persuader—in this case, the Communication Manager. (This conclusion sub-state or set of sub-states can also be referred to as the goal, objective, decision, viewpoint, or bias—the latter from those mostly hostile to the result.)

The dialogue starts as a finite state machine, but because it is dynamically responsive through the actions of the Communications Manager, the preferred embodiment overcomes the major limitation of all FSMs—the limited possibilities they contain, which is dependent upon the number of distinct states (their ‘memory’). For each Field Operative the instantiation of the dialogue represents at the point of live interchange not just the original model dialogue, but the sum of all aggregate modifications of all the sub-states from all previous interactions of other Field Operatives with other Targeted Individuals.

However, as with FSMs, the dialogue as embodied in the present invention shares the power of having both entry conditions (or constraints) and exit conditions (or consequences) which can incorporate actions and decisions that are not experienced directly by the Field Operative or Targeted Individual, save by the change in the transition paths through the dialogue subsequently experienced or, for the Field Operative, otherwise experienced in different instantiations (with a different Targeted Individual or at a different ‘run’ with the same one) of the dialogue. For example, if on a first visit at a specific street address the result was a Not Home', the Field Operative may not know at the time that the result is a posting to the Communications Manager that a follow-up visit must be arranged; while if the visit had instead met an intentionally-terminating rejection, the result could be the dropping of that specific Targeted Individual from the datasource of Targeted Individuals.

Because the invention as disclosed in the preferred embodiment, when managed by the Communications Manager can collect data (through each handset [9]) and store it in the datasource incorporating specific data records of potential Targets [5], it can effectively “count”, and thus has greater expressive power than either a FSM or a Deterministic Finite Automaton (‘DFA’); though less than a Turing Machine, the invention is roughly equivalent to an expert system. When the Communications Manager who created the original model dialogue with all of its sub-states (each also being definable as a node) and connections (each such also being definable as a transition) uses the collected data from each and all handsets [9] as used by the Field Operatives, and then effects a dynamic modification of the dialogue, the DDME may be more accurately described as a dynamically-enhanceable DFA as it is adaptive when used to real-world conditions. (Unlike the hypothetical Turing Machine, the DDME does not contain unlimited memory; even petabytes fall infinitely short of such). In short, this invention is a ‘political computer’ for a goal-oriented dialogue, with a language and grammar limited to the terms and qualities of the logic and data contained in the datastores and responses as managed by the Communications Manager.

A further, and major, differentiation between a script and a dialogue, is that a dialogue implies an exchange, not merely an interaction, between the participants; and an exchange can be of and of the set of ideas, questions, and commitments. For example, in a political campaign, a Field Operative may obtain a commitment of support contingent upon the campaign providing follow-up information on a specific issue, or contingent upon the campaign providing a reminder call to the Targeted Individual to go vote on Election Day.

Another form of commitment can be a monetary one, or even the exchange of full ‘consideration’ (one or more items or services of value transferred from each party to the other which the parties have agreed have an equivalent value). This sort of exchange is generally considered a ‘financial’ exchange even if it involves elements of barter, as such transactions are considered reducible to some determinable monetary value with money used as the grounding measuring unit. Financial exchanges are also a specific sub-class of dialogue (even the Supreme Court has observed an equivalence between money and free speech); but a financial exchange dialogue is a dialogue with specific, unique, additional requirements and needs that are not necessary in other portions of a larger dialogue (a commercial transaction) in which most financial exchanges are typically embedded. For example, in either a personalized sales visit or effort to deliver goods, services, or customer support (whether door-to-door or through a centralized website), part of each such interaction is the dialogue whereby the geospatial location of the customer and the identity of the recipient must be validated and the capacity to commit verified. This aspect of a commercial exchange dialogue is what prevents, as the saying goes, the problems which otherwise can arise from tele-distance—or in other words, from having Fido or Baby order pizzas by the truckload. It is precisely this sort of validating fidelity between ‘record’ and ‘reality’ that invalidates commercially or even personally disastrous errors summed up in the saying: “On the Internet, no one can tell you're a dog.” That's not true if all you can do is bark when the Field Observer (or canvasser, or contact person) engages you in a direct, live, dialogue!

Financial exchanges must be secure—the communication links must not be subject to third-party distortion or interception; financial exchanges must be accountable—there must be a record with each party having at least the option of accessing a copy and reviewing it; and each such exchange must have its context (parties, location, date and time) set to ensure it is unique, and neither intentionally nor inadvertently nor maliciously duplicated or disappeared. Furthermore, most financial exchanges have additional constraints which are required for prudent protection of both parties; there generally are constraints, such as limit checks (to ensure no more is promised than can be delivered) or specific legal constraints particular to any of the Targeted Individual, dialogue goal, or Field Operative and their respective authorities to make such commitment. As the preferred embodiment of the DDME incorporates each of secure, accountable, and constraint-testing communications link capabilities its dialogues can include financial exchange sub-states.

All of these special requirements are conditioned by the nature of the specific state of the dialogue, that being one of making a financial exchange (also referable to as a ‘financial exchange state’, a ‘financial exchange sub-state’, or a ‘financial state’). None of the special requirements need depend upon either of the individuals engaging in the face-to-face, live interaction (the Field Operative or Targeted Individual), nor additionally or separately the supervising Communications Manager, specifically and actively invoking these special requirements. The preferred embodiment of the invention provides for each and all of the above through entering a special sub-state (which in turn contains a series of sub-states) of the dialogue, a special sub-state that is particular to a financial exchange. This difference can but need not be indicated to either or both the Field Operative and Targeted Individual by a changed representation in the visual, textual, or audible display.

One example of this special sub-state of a Financial Exchange State is shown in FIG. 15; although particular aspects of the hardware embodiment are not shown therein but are now explained. Both the computer [7] and each handset [9] in the preferred embodiment comprise as part of their operating hardware and software, the means for entering into a ‘secure transaction’ communications link between them. For example, each may have the ability, if they each are capable of using standard World Wide Web protocols, of accessing and using the Secure Socket Layer (SSL) protocol or its equivalent(s), and thus in this sub-state of the dialogue will use the ‘https://’ rather than the less-secure ‘http://’ interaction protocol. Alternatively, each may have a shared telephony encryption mode and a unique coupling of access keys for data transfer, and so all data relevant to the financial exchange would be encrypted, exchanged, decrypted by the recipient, and thus protected during the communication exchange. What is important is that whenever the dialogue between a particular Field Operative and a Targeted Individual enters into a ‘financial exchange’ sub-state, any non-null combination of the means for assuring the requirements for such will automatically be invoked. This automatic invocation would be beyond the control of any of the Field Operative, Targeted Individual, or Communications Manager, to thoroughly ensure the requisite accountability and security needs even against the intentional effort to subvert the same by any of those individuals.

As can be seen in FIG. 15, a question by the Field Operative may ask whether the Targeted Individual wishes to enter a financial exchange [131]. (Not shown is an alternative entry mode, where the Targeted Individual may spontaneously offer to do so; in this case, the preferred embodiment would allow the Field Operative to use the handset controls to invoke the financial exchange sub-state, which would then follow the sub-path substantially equivalent to that shown for a positive response to the invoking question [131] in FIG. 15.

If the answer is not a positive one, then the financial exchange sub-state is not entered, and the dialogue moves to the next non-financial sub-state, as shown by the left-most arrow connecting the now-rejected question [131] and the next interaction, in this example, a request for non-financial support [149].

Alternatively, if the answer is positive, then as shown by the right-most arrow depending from the invoking question [131], the preferred embodiment enters into a special financial exchange sub-state, which starts by activating a Secure Transaction communications mode [133] from the handset. A specific limit-test may be applied [135], in this case one pertinent to reporting requirements for political campaigns under the FPPC rules and regulations; when the amount offered is equal to or over one hundred dollars, specific record and report of this must be maintained by the overall campaign; and in the preferred embodiment, this report is automatically generated by the act of a qualifying contribution [137] —even if the present contribution only exceeds the limit when summed with other, prior, contributions on record for that specific Targeted Individual [139]. Then the transfer is effected by the means of choice of the Targeted Individual (Credit Card, automatic account balance transfer (PayPal, bank account), or cash; optionally a check, though that choice is not shown) [141]. The handset either sends the authorization and amount to the computer or contacts the authorized financial account while reporting this to the computer, and then uses the authorization and amount to activate a transference transaction, accessing the specific account for that particular Targeted Individual, validating the existence of the proffered amount, executing the transaction, and validating that the transaction has occurred [143], with all of these effecting and accounting steps taking place automatically upon receiving the authorization, access, and sourcing information from the Targeted Individual (these steps are not shown as they are known in the prior art). Next is the acknowledgment stage, where the Targeted Individual is asked whether a specific receipt is required [145]; and if not, then the need for security and accountability has ended, and the financial exchange sub-state is closed and exited [147], with the dialogue moving to the next interaction, which is the same as if there had been no financial exchange, i.e. the request for a non-financial support [149].

As has been described above, the dialogue as a whole with its states, sub-states, and transitions, is originally designed and created by the Communications Manager, yet is subject to dynamic adaptation according to the experiences of the set of Field Operatives' interactions with Targeted Individuals, through the Communications Manager's use of the DDME. After experiencing far more requests for receipts than had been anticipated (or perhaps, problems with a Field Operative ‘losing’ cash), experiencing far more generous support—too generous, as being too often unfulfillable—than expected, the Communications Manager can use the DDME to re-design the financial exchange sub-state, and then through his computer provide the re-designed and improved financial exchange sub-state to each handset for each Field Operative. This updated financial exchange sub-state is shown in FIG. 16. Not only does it incorporate an additional sub-sub-state wherein a receipt (and thank-you letter) is automatically generated by the computer and mailed to the specific Targeted Individual [151], if one is requested or whenever a cash contribution is made; but also the contribution offered is first attempted—and if it fails, as shown by the top arrow leaving the transaction attempt [143], then a lower amount (this ‘x’ being no more than the maximum available within the authorized account) is requested through a second new sub-sub-state [153], so only the amount actually transferred (as opposed to being offered) is tested against the limits [135, 139] as in FIG. 15.

Because both the handsets [9] and the computer [7] comprise both dual voice and data telephony capabilities, in the preferred embodiment of the invention the DDME uses these to effect a geospatial coordination between the data record for a Targeted Individual and the actual live interaction between each tuple of Field Operative and Targeted Individual, and does so whether that interaction is face-to-face of over a voice (or voice and vision) telephonic communication. It also enables the Communications Manager to use the DDME to control communications which use computer-based telephony services (such as Skype) to effect voice telephony, or voice-and-video exchanges. In a further embodiment of this invention the DDME can be used along with signal-separating and voice recognition tools to effect multiple-parallel-and-cooperative (i.e. collaborative) communication links to progress through the dialogue with a set of Targeted Individuals and Field Operatives without requiring a one-to-one tuple pairing thereof.

The geospatial and telephonic linkages are, in the preferred embodiment of the invention, integrated with the DDME and thus effect the interactive and dynamic modification and adaptation of the dialogue to the collected and analyzed set of tuples and instantiations of the dialogue—up to and including all instantiations which have reached a currently-active state for any tuple of Field Operative and Targeted Individual. This integration of geospatial and telephonic interchange capabilities effects a real-time fidelity validation of the record through cross-checked referent comparison analytics, which then feed back into the dynamic management of the dialogue. Such geospatial coordination can be effected through comparative use of any of the set of data and voice telephony links, reported data from a live interaction between a Field Operative and a Targeted Individual and the respective data record for their current location, and any of the attributes of the datasources.

The analytics used in the DDME can be designed to work with any of the attributes of any of the datasources and data records, and when modified through the efforts of the Communications Manager using his computer, can use new or previously-unincorporated data (including the geospatial data from the integrated geospatial capabilities) to craft custom analytics for that dataset or experienced data, instead of having to depend solely on analytics designed for predetermined, pre-categorized, or pre-provided to the DDME.

Thus the DDME enables the Communications Manager to analyze, and identify, and then validate or modify to correct, any of the set of data record, datasources, or dialogue, into a more accurate representation of the reality experience by the Field Operative(s) and Targeted Individual(s). If a geospatial measurement deviates from the data record reported by the Field Operative, the Communications Manager can be advised of the deviation and directly supervise, or contact, that specific Field Operative to obtain an explanation of the deviation (i.e. there is what can, depending on context, be thought of as a ‘shenanigans detection’). This real-world interaction can assure fidelity despite nominal deviation; as the Field Operative may encounter a Targeted Individual out walking some distance away from the address used to identify that Targeted Individual and either personally recognize them or have some other identification means (such as an introduction) proffered outside the scope of the DDME, and thus initiate the interaction and dialogue at a non-record geolocation.

Alternatively, a Field Operative may encounter a number of Targeted Individuals at one specific residence (at a party there) and serially engage with each, speeding up the coverage of the geospatially-differentiated record but real-time co-located people. Furthermore, a Field Operative can use any set of the data or voice telephony connections to advise the Communications Manager of a condition not reported but presently experienced by the Field Operative which may affect the process (such as finding a sign prohibiting access, i.e. a “No Trespassing” sign; encountering a locked gate backed by a hostile pit bull; or a report that the Targeted Individual is a worker on a night shift and does not respond to any attempt at a face-to-face contact before 4 p.m.). Depending on the capabilities of the handset, if the Field Operative can use it to take and send a picture, then the data telephony means can be used to send to the Communications Manager a visual image—even a moving one—of the experience; and as the voice telephony incorporates an audio component, an audio record can likewise be transmitted. Similarly, should a specific Targeted Individual indicate during the dialogue that he might like a specific follow-up item delivered, the display of the handset would use the data telephony connection (or handset memory) to display an image thereof, for example, of a campaign's yard sign. Depending on the respective capabilities, either the handset or computer or both together, might take in an image of the Targeted Individual's yard, combine it with the image of the yard sign, and display for the Targeted Individual's approval and selection, a dynamically-created (i.e. “Photoshopped”) image of the yard sign as it would appear on the Targeted Individual's lawn.

Thus the DDME enables the Communications Manager to effect an integration between the map and the actual experienced ‘image’ on the ground; and the Field Operative to effect adaptable reporting based on the actual experienced reality. In a further enhancement to the preferred embodiment each of these integrations is effected through a ‘drag and drop’ capability which lets the CM effect an integration between the map and the actual experienced reality reported by the Field Operative on the ground.

In the preferred embodiment the dialogue may actually comprise a set of multiple, slightly varying versions kept on the CM's computer, allowing a single question to be asked with multiple slight variations which may affect connotative meaning; also, the identical question can be evaluated across multiple Field Operatives with differing, or similar, qualities; or the identical question can be evaluated across multiple Targeted Individuals with differing, or similar, qualities—and the results from the total aggregate set of responses can be then analyzed according to any of the similarities or differences of question, questioner, response, and respondent. This allows the Communications Manager to use the DDME to not only determine for which particular quality of a sub-set of Targeted Individuals (‘men’; ‘women’; ‘voters aged 20-31’; ‘voters aged 54-67’; ‘ethnically Hispanic, multi-generational American voters’; ‘ethnically Hispanic, first-generational American voters’), a particular phrasing of a question may produce a desired outcome (and thus the ‘most effective response’). An example of this is shown in FIG. 17. Two different phrasings for the same general decision point are used, one more neutral and one more hostile to a ‘yes’ response [163]. The aggregated responses to date, as shown on the display of the Communications Manager's computer [7] show a variance in responses [164]. Also, a difference in the Field Operative within the same precinct [165] shows a steeper variance in responses [166]. If the Communications Manager wished to effect a negative response in the rest of the Targeted Individuals, particularly in that precinct, he might alter the dialogue available to limit that stage to the form of question which is more hostile and direct the remaining contacts to be made by Field Operative Smith.

In the preferred embodiment the DDME can send to each handset a geospatial map indicating the geographic ‘place’ for that Field Operative to be working in. This map can be augmented 1154 with various information and symbology to represent a wide array of information, such as from the location and status of all voters that given Field Operative is to visit; or as reported 1156 by any of the set of Field Operative to the CM and stored within the computer thereafter.

This information for each individual Field Operative and for any set of Field Operatives is also viewable on the display of the Communication Manager's computer [7]; and the Communications Manager can modify the area of the map which any individual Field Operative or set of Field Operatives is to be working on as they are engaging in the dialogue(s) with any of the potential Targeted Individuals. This enables a Communications Manager to dynamically change the geographic range and route to account for conditions which are experienced and reported by one or more Field Operatives in the real world (such as a power failure cutting lights and traffic controls, or a temporary traffic jam stopping traffic) and adjust the workload amongst the set of Field Operatives, making their intended interaction territory more consonant with that attainable in reality, rather than on the stored map.

The analytics of the DDME (generally found and used in the Analytical Function Engine) in the preferred embodiment comprise, or have access to, means by which they can be specifically tuned or suited to the outcome desired for the dialogue as intended by the Communications Manager, using the experienced qualities and responses for the measurement of effectiveness rather than the pre-interaction records. Such custom analytics can then be fed back into the dynamic management of the dialogue (by updating and modifying any set of the data record and datasource and dialogue), correcting consequently through the DDME the dialogue and making it a more accurate representation of the experienced complexities of the real world.

Additionally, as the handset comprises both data and telephony capabilities, it is possible for the Field Operative, when the Communications Manager has transmitted the enabling authorizations and information, to send and receive information interacting with the Targeted Individual through any third-party communications device from a social-media, statistical, governmental or other third party providers via an API. In the alternative use of the DDME as a tool for effecting a canvassing phase or live-contact interaction, this outreach can be leveraged through such as long as the appropriate API and sufficient bandwidth and memory 1184 capability exist on the handset.

In a further embodiment of this invention, the computer and display used by the Communications Manager will translate between textual (serial, particularly list-based) representations of data, graphical (abstract line-and-area-based shapes; 2-D or 3-D; chart, pie, or other graph form), and pictorial (image, satellite or photographic or visual feed) representations of the data and connections relating to any of the tasks, structures, relations, locations, qualities, or procedural activities of the interaction(s) amongst the same. These varied form of representation (text, graphical, pictorial) would include representations of any of the goals, objectives, state-transition-diagrams, activities, analytical options or activities, and results of their interactions which are pertinent to the dialogue management and effected by the architecture of the invention.

In yet a further embodiment of the invention, which is dependent upon the functional capabilities of the hardware of at least one non-zero subset of the set of handsets, any of the handsets with sufficient processing and communication capacity could become the computer (thus that handset being a ‘substitute computer’) and that handset's user a Communications Manager, with the allocation of tasks (particularly of analysis and dynamic, interactive 1200 management of the dialogue structure and its uses by all or any subset of the Field Operatives) being non-hierarchical and effected through mobile telephony or short-range EM communication media to which said non-zero subset of the set of handsets share equal effective access. As a further expansion upon this further embodiment, if one or more handsets suitable to serve as the computer by possessing sufficient capacity (in processing, display, I/O, memory, and communications capabilities) are available along with any combination of mobile telephony, short-range EM communication media, or Web connections enabling the sharing of the tasks and data, this DDME can have a task-oriented hierarchical (or non-hierarchical) implementation of the activity depending upon the human-controlled distribution of authorization codes amongst the set of such substitute computer(s), with the limits of activities, interactivity, modification or deletion capabilities, and communication initiation, alteration, or repetition, governed by the specific authorization codes thereto. In these expanded embodiments the human users of any authorized handset or computer would share a fungible feature set and thus a common user experience (greatly easing training concerns). Moreover, these expanded embodiments can be used to effect superior intergroup communication, providing an easy discovery mechanism (through the exchange of authorization codes) to affinities in any of goals, processes, members, or Targeted Individuals, so as to change this information from being a transfer ‘between’ groups to information shared ‘amongst’ groups. As a further corollary effect these expanded embodiments would incorporate through the properly designed and distributed authorization codes, at least one easy means for a distributed dispatch of any of the data, processes, experiences, and fidelity of existing information and mappings, amongst the now-connected groups. To the extent that any of the authorization codes allowed open distribution, or within any further group, open distribution upon the proof of meeting the constraining quality(ies) (e.g. membership, paid-up standing, demographic matching, etc.) used by the distributing source to any member of that group, this would enable a distribution to be spread through the efforts of those individuals taking up for the sake of this further distribution the role of the Communications Manager responsible for managing the dialogue of transmission of the authorization and connectivity.

In a further embodiment of the invention, through the further inclusion of automated information dispatch according to any set of the constraints and authorization codes and other limitation means, including hardware capacities, transmission qualities, and regulatory and legal barriers (e.g. the ‘Great Firewall’ of the Peoples Republic of China; or European Union prohibitions against the offer of National Socialist Peoples Party memorabilia), outbound information from any Communications Manager could be extended through the entirety of the connected set of handsets and computers; and, also using identifying tuples of device and user, from any external third source to the correct, fidelity-assured, inbound target for such a communication. This inbound routing would transit through the various mapping(s) between symbolic identifier as found in a data record and actual device, and Targeted Individual (as a real person) and identifier (simple or complex) as found in a data record (as name, identification number, customer i.d., business name and job title). Furthermore, through the mapping representation substitution means available to the Communications Manager as described above, the collection of individual human/device target pairings into a specific collective entity (campaign work team, union, neighborhood association, corporate employee, etc.) could be both identified and represented, allowing the direction of messages and particularly the further management of a dialogue from a source to that now-mapped collective entity. For example, having authorized any retailer, wholesaler, or product representative to grant an access and unique identification code to any customer for a specific product (such as a high-speed, wireless printer), the manufacturer of that product could by using the authorization codes received direct a dialogue concerning any issue (especially product support, product safety, or product upgrades) to precisely those customers.

In another further embodiment of the invention, any handset could be replaced by a fixed-in-place, human-useable interface device including a kiosk.

In a further embodiment of the invention a special substate of the dialogue invites a Targeted Individual to become a new Field Worker, which invitation incorporates the incentives, training, and empowering and connecting functionalities as set by the Communications Manager in the DDME, and which invitation when accepted and determined as compatible, connects the new Field Worker to the existing set.

In another further embodiment of the invention any of the set of Communication Manager and Field Operatives when provided with the authorization and translation capabilities, can input through any handset from any third-party hardware and datasource that third-party's data records of potential, additional, Targeted Individuals, whether that source be a simple contacts list from a smartphone, a customer directory from a Personal Information Manager, or a complete support database from a allying organization (or newly acquired subsidiary). As the authorizations can additionally, as to the data records which are to be transferred to the DDME, be provided and controlled from the Targeted Individual(s), this would enable the Communications Manager, through a specific Field Operative, to effect an open-ended input cascade subject only to the decisions of successive Targeted Individuals to further extend the access of the DDME to their particular datarecords. As the set of Targeted Individuals can include those with extensive third-party-sourced personal-contact datarecords (for example, at a ‘social-networking’ website), the DDME could be granted access via a shared authorization from a specific Targeted Individual to each whom that Targeted Individual has ‘friended’ or otherwise recorded as a personal and authorized-to-share contact. Thus, any set of connectivity (consisting of the connections and authorizations to follow along and use the same) can be communicated through the set of Targeted Individuals and Field Operatives' handsets, to the DDME and thus be accessible to the Communications Manager.

In another further embodiment of the invention the Communications Manager can, using the DDME, effectively transmit to any set of handsets a new ‘app’ which represents a modified dialogue, including the triggering conditions and subsequent activities automatically linked to the sub-state entry and exit transitions, constraining the app by the provision or lack thereof of any sub-set of the datasources, any authorization control structures and authorization releases (or preconditions), or any combination thereof. In this way, similar to the transmission of a new ‘app’ via a Java Pcode packet, or of a newly-compiled subprogram using a commonly-shared API or developers' toolkit, a Communications Manager can spawn off and delimit either or both hierarchy or peer structured new instantiations of any dialogue under the Communication Manager's authorization and control and reachable by the DDME through the Communication Manager's computer.

The above description of the invention is illustrative and not restrictive. Many variations of the invention may become apparent to those of skill in the art upon review of this disclosure. The scope of the invention should, therefore, be determined not with reference to the above description, but instead should be determined with reference to the appended claims along with their full scope of equivalents.

While the present invention has been described in connection preferred embodiment, these descriptions are not intended to limit the scope of the invention to the particular forms (whether elements of any device or architecture, or steps of any method) set forth herein. It will be further understood that the elements or methods of the invention are not necessarily limited to the discrete elements or steps, or the precise connectivity of the elements or order of the steps described, particularly where elements or steps which are part of the prior art are not referenced (and are not claimed). To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A dynamic dialogue management engine (‘DDME’) for use by a Communications Manager (‘CM’) to multiple (serial and parallel) communications with a set of Targeted Individuals (‘TIs’), said communications each being a unique instantiation of a dialogue, said DDME further comprising:
a computer, on which said dialogue is stored and through which the CM creates, manages, and changes the dialogue and all subsequent instantiations thereof;
means for any set of voice, visual, and data communications;
a datasource of possible communication links, with individual data records therein having both identifying information as to a Targeted Individual potentially within the set of Targeted Individuals, and information enabling a communication link to be effected with that specific Targeted Individual;
a distinct datasource of possible Target Individuals, with individual data records therein having both identifying information as to a specific potential Target Individual and about any set of qualities or categorizations recorded about that specific potential Target Individual, that indicate that he belongs to the set with whom a communication is desired and thus a dialogue worth attempting;
a Core Datasource, comprising a selection of data records combining, for each such data record, the information enabling a communication link to be effected with a specific Targeted Individual and identifying information as to a specific potential Target Individual and information as to the specific set of qualities or categorizations which indicate that a communication effort is desired and thus a dialogue worth attempting;
a datasource of Field Operatives;
a dialogue which is to be entered into and interactively communicated with a Targeted Individual by a Field Operative in a live, direct contact;
a plurality of handsets, each containing an instantiation of the dialogue, a display on which the dialogue's most current sub-state can be shown to the Field Operative and Targeted Individual, with controls enabling the input from the Targeted Individual to be entered into the handset to effect the transition to the next sub-state, telephony links capable of any set of voice, visual, and data communications;
an Analytical Function Engine which can take the data from any set of the handsets, Core Datasource, datasource of possible communications links, distinct datasource of possible Target Individuals, or datasource of Field Operatives, and perform comparative, aggregate, deconstructive, mathematical, and other functional operations thereon, as determined by the CM within the computer's then-current capabilities, whether using software within the DDME or external thereto;
and,
a dialogue-management tool which enables the CM to construct, monitor, modify, or delete the structure of the dialogue, including any set of its sub-states, conditions of entry and actions upon exit of any state, actions upon any transition between one sub-state and the next (including final exit from the dialogue).

2. A DDME as described in claim 1, wherein the dialogue-management tool further comprises:
means for translation of text comprising an expression which is part of an exchange in a first language into an equivalent expression in a second language;
input means for the CM to select text comprising an expression in a first language to be so translated;
storage means for the DDME to retain both the equivalent expression in a second language and the pairing of the translation; and,
output means for the DDME to pair the translated text within any sub-state of the dialogue where the translated text comprising an expression exists, with the translated text, within the display of that sub-state.

3. A DDME as described in claim 1, wherein the dialogue which is to be entered into and interactively communicated with a Targeted Individual by a Field Operative in a live, direct contact further comprises at least one financial exchange state, with secure, accountable, and constraint-testing communications link capabilities.

4. A DDME as described in claim 1, further comprising means for geospatial coordination through comparative use of any of the set of data and voice telephony links, reported data from a live interaction between a Field Operative and a Targeted Individual and the respective data record for their current location, and any of the attributes of the datasources.

5. A DDME as described in claim 4, further comprising a drag and drop capability for the CM to effect an integration between the map and the actual experienced reality reported by the Field Operative on the ground

6. A DDME as described in claim 1, wherein the a dialogue which is to be entered into and interactively communicated with a Targeted Individual by a Field Operative in a live, direct contact may actually comprise a set of multiple, slightly varying versions kept on the CM's computer, allowing a single question to be asked with multiple slight variations which may affect connotative meaning.

7. A DDME as described in claim 1, further comprising:
a geospatial map indicating the geographic ‘place’ for that Field Operative to be working in, stored in the DDME and transferable to that Field Operative's handset;
means for that map to be augmented with various information and symbology to represent a wide array of information, specifically including both that given to the Field Operative from the DDME's database(s) and that by any of the set of Field Operative to the CM and stored within the computer.

8. A DDME as described in claim 1, wherein the analytics used in the Analytical Function Engine further:
comprise means by which they can be specifically tuned or suited to the outcome desired for the dialogue as intended by the Communications Manager, using the experienced qualities and responses for the measurement of effectiveness rather than the pre-interaction records; and,
can then be fed back into the dynamic management of the dialogue (by updating and modifying any set of the data record and datasource and dialogue), correcting consequently through the DDME the dialogue and making it a more accurate representation of the experienced complexities of the real world.

9. A DDME as described in claim 1, wherein each of the plurality of handsets further comprises both data and telephony capabilities which can send and receive information interacting with the Targeted Individual through any third-party communications device from a social-media, statistical, governmental or other third party providers via an API.

10. A DDME as described in claim 1, wherein the computer which is used by the Communications Manager further comprises a display and hardware enabling it to translate between textual (serial, particularly list-based) representations of data, graphical (abstract line-and-area-based shapes; 2-D or 3-D; chart, pie, or other graph form), and pictorial (image, satellite or photographic or visual feed) representations of the data and connections relating to any of the tasks, structures, relations, locations, qualities, or procedural activities of the interaction(s) amongst the same.

11. A DDME as described in claim 1, wherein the dialogue further comprises a special substate of the dialogue which invites a Targeted Individual to become a new Field Worker, which invitation incorporates the incentives, training, and empowering and connecting functionalities as set by the Communications Manager in the DDME, and which invitation when accepted and determined as compatible, connects the new Field Worker to the existing set of Field Workers.

12. A DDME as described in claim 1, wherein the Communications Manager can, using the computer, effectively transmit to any set of handsets a new ‘app’ which represents a modified dialogue, including the triggering conditions and subsequent activities automatically linked to the sub-state entry and exit transitions, constraining the app by the provision or lack thereof of any sub-set of the datasources, any authorization control structures and authorization releases (or preconditions), or any combination thereof.

13. A dynamic dialogue management engine (‘DDME’) for use by a Communications Manager (‘CM’) to multiple (serial and parallel) communications with a set of Targeted Individuals (‘TIs’), said communications each being a unique instantiation of a dialogue, said DDME further comprising:
a datasource of possible communication links, with individual data records therein having both identifying information as to a Targeted Individual potentially within the set of Targeted Individuals, and information enabling a communication link to be effected with that specific Targeted Individual;
a distinct datasource of possible Target Individuals, with individual data records therein having both identifying information as to a specific potential Target Individual and about any set of qualities or categorizations recorded about that specific potential Target Individual, that indicate that he belongs to the set with whom a communication is desired and thus a dialogue worth attempting;
a Core Datasource, comprising a selection of data records combining, for each such data record, the information enabling a communication link to be effected with a specific Targeted Individual and identifying information as to a specific potential Target Individual and information as to the specific set of qualities or categorizations which indicate that a communication effort is desired and thus a dialogue worth attempting;
a datasource of Field Operatives;
a dialogue which is to be entered into and interactively communicated with a Targeted Individual by a Field Operative in a live, direct contact;
a plurality of handsets, each containing an instantiation of the dialogue, a display on which the dialogue's most current sub-state can be shown to the Field Operative and Targeted Individual, with controls enabling the input from the Targeted Individual to be entered into the handset to effect the transition to the next sub-state, telephony links capable of any set of voice, visual, and data communications;
an Analytical Function Engine which can take the data from any set of the handsets, Core Datasource, datasource of possible communications links, distinct datasource of possible Target Individuals, or datasource of Field Operatives, and perform comparative, aggregate, deconstructive, mathematical, and other functional operations thereon, as determined by the CM within the computer's then-current capabilities, whether using software within the DDME or external thereto; and,
a dialogue-management tool which enables the CM to construct, monitor, modify, or delete the structure of the dialogue, including any set of its sub-states, conditions of entry and actions upon exit of any state, actions upon any transition between one sub-state and the next (including final exit from the dialogue);
wherein any of the plurality of handsets which comprise sufficient processing and communication capacity can be used as the computer, on which said dialogue is stored and through which the CM creates, manages, and changes the dialogue and all subsequent instantiations thereof.

14. A DDME as described in claim 11, when at least one of the plurality of handsets is suitable to serve as the computer by possessing sufficient capacity (in processing, display, I/O, memory, and communications capabilities) and is available along with any combination of mobile telephony, short-range EM communication media, or Web connections enabling the sharing of the tasks and data, the DDME can effect a task-oriented hierarchical (or non-hierarchical) implementation of the activity depending upon the human-controlled distribution of authorization codes amongst the set of such substitute computer(s), with the limits of activities, interactivity, modification or deletion capabilities, and communication initiation, alteration, or repetition, governed by the specific authorization codes thereto.
